(19) United States
(12) Patent Application Publication
(10) Pub. No.: US 2014/0297843 A1
(43) Pub. Date: Oct. 2, 2014

(54) APPARATUS AND METHOD FOR MANAGING PRESENCE INFORMATION

(71) Applicant: FUJITSU LIMITED, Kawasaki-shi (JP)

(72) Inventors: Koichi SHIGA, Mishima (JP); Masato Suzuki, Chofu (JP); Yoshinori Shimada, Ohta (JP)

(73) Assignee: FUJITSU LIMITED, Kawasaki-shi (JP)

(21) Appl. No.: 14/177,870

(22) Filed: Feb. 11, 2014

(30) Foreign Application Priority Data
Mar. 29, 2013 (JP) 2013-072057

(51) Int. Cl. H04L 12/26

(52) U.S. Cl. CPC H04L 43/04
USPC 709/224

(57) ABSTRACT

An apparatus provides presence information indicating a state of users for devices associated with the users. The apparatus collects, from the devices, pieces of first information indicating which of a plurality of networks is accessible from each of the devices, and identifies combination of a plurality of pieces of the first information collected from a plurality of devices associated with a user by using second information indicating correspondence between the user and the plurality of devices. The apparatus generates presence information including information indicating a location of the user, based on the combination.

### CROSS-REFERENCE TO RELATED APPLICATION

This application is based upon and claims the benefit of priority of the prior Japanese Patent Application No. 2013-072057, filed on Mar. 29, 2013, the entire contents of which are incorporated herein by reference.

### FIELD

The embodiments discussed herein are related to apparatus and method for managing presence information.

### BACKGROUND

Currently, an information processing system for managing a user's presence status (also referred to as presence or presence information) has been used. This information processing system includes client devices used by a user and a server device that manages presence. The server device collects information about the client devices from them and provides the information as presence information for the client devices. Sharing of presence information among users may make communication (such as, for example, making a call, passing documents, or asking for a review) smooth.

There is a proposed technique, in which a first terminal and a second terminal exchange their identifiers, the first terminal and the second terminal transmit a request for pairing both the terminals to a presence server, and the presence server pairs and manages the first terminal and the second terminal. When receiving a presence information request about the first or second terminal, the presence server notifies the requesting terminal of the presence information about the first and second terminals.

Japanese Laid-open Patent Publication No. 2011-15296 and Japanese Laid-open Patent Publication No. 2005-202789 are examples of related art.

### SUMMARY

According to an aspect of the invention, an apparatus for providing presence information indicating a state of a user is provided. The apparatus stores first information indicating correspondence between a user and a plurality of devices. The apparatus collects second information indicating which of a plurality of networks is accessible to each of the plurality of devices, from the plurality of devices, identifies combination of the second information collected from the plurality of devices associated with the user using the first information, and generates the presence information including information indicating a location of the user based on the combination.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a presence management system, according to a first embodiment;

FIG. 2 is a diagram illustrating an example of a presence management system, according to a second embodiment;

FIG. 3 is a diagram illustrating an example of a hardware configuration of an internal server, according to an embodiment;

FIG. 4 is a diagram illustrating an example of a hardware configuration of a mobile phone, according to an embodiment;

FIG. 5 is a diagram illustrating an example of software of a presence management system, according to an embodiment;

FIG. 6 is a diagram illustrating an example of an account management table, according to an embodiment;

FIG. 7 is a diagram illustrating an example of a group management table, according to an embodiment;

FIG. 8 is a diagram illustrating an example of a presence management table of an internal server, according to an embodiment;

FIG. 9 is a diagram illustrating an example of a presence management table of an external server, according to an embodiment;

FIG. 10 is a diagram illustrating an example of a group management table, according to an embodiment;

FIGS. 11A to 11C are diagrams illustrating examples of acceleration pattern information;

FIG. 12 is a diagram illustrating an example of a destination management table, according to an embodiment;

FIG. 13 is a diagram illustrating an example of a state management table, according to an embodiment;

FIG. 14 is a diagram illustrating an example of a member presence table, according to an embodiment;

FIG. 15 is a diagram illustrating an example of an operational flowchart for presence determination through a client, according to an embodiment;

FIG. 16 is a diagram illustrating an example of an operational flowchart for monitoring operations performed by a client, according to an embodiment;

FIG. 17 is a diagram illustrating an example of an operational flowchart for detecting operations performed by a client, according to an embodiment;

FIG. 18 is a diagram illustrating an example of an operational flowchart for determining a travel status of a client, according to an embodiment;

FIG. 19 is diagram illustrating an example of an operational flowchart for determination of customer serving performed by a client, according to an embodiment;

FIG. 20 is a diagram illustrating an example of an operational flowchart for notification of state changes performed by a client, according to an embodiment;

FIG. 21 is a diagram illustrating an example of an operational flowchart for processing performed by an internal server, according to an embodiment;

FIG. 22 is a diagram illustrating an example of an operational flowchart for processing performed by an external server, according to an embodiment;

FIG. 23 is a diagram illustrating an example of an operational flowchart for providing presence information for a client, according to an embodiment;

FIG. 24 is a diagram illustrating an example of an operational flowchart for processing performed by an internal server during presence change, according to an embodiment;

FIG. 25 is a diagram illustrating an example of an operational flowchart for processing performed by an external server during presence change, according to an embodiment;

FIG. 26 is a schematic diagram illustrating an example of referencing presence information, according to an embodiment;

FIG. 27 is a schematic diagram illustrating an example of synchronization of presence information, according to an embodiment;

FIG. 28 is a diagram illustrating an example of a presence management table of an internal server, according to an embodiment; and

FIG. 29 is a diagram illustrating an example of an operational flowchart for processing performed by an internal server, according to an embodiment.

### DESCRIPTION OF EMBODIMENTS

One user may use a plurality of client devices. In this case, the management of the correspondence between the user and the client devices is considered. However, the notification of only the presence information for each terminal as in the above example may make it difficult to appropriately grasp the location of the user. For example, the user does not necessarily carry all of the plurality of clients at any time. The user may carry one client device to a second area while leaving another client device in a first area. At this time, even if the server device individually provides presence information indicating that, for example, the user corresponding to each client device is seating, busy, or so on, it is difficult for other users to determine the location of the user appropriately based on the presence information.

Embodiments of the present disclosure will be described with reference to the drawings.

### First Embodiment

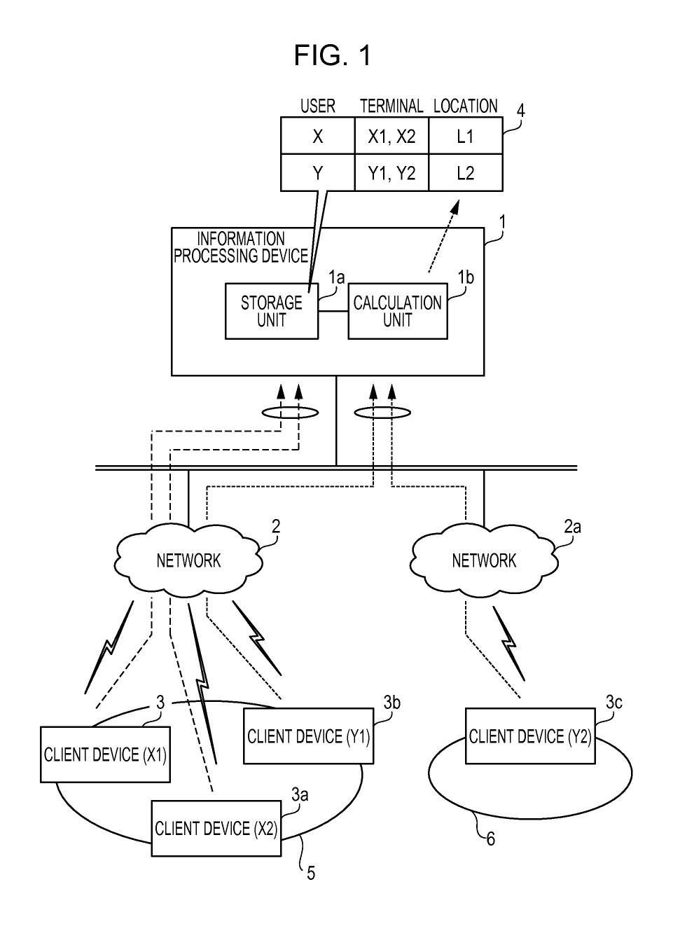

FIG. 1 is a diagram illustrating an example of a presence management system, according to a first embodiment. The presence management system according to the first embodiment includes client devices 3, 3a, 3b, and 3c that are associated with users and an information processing device 1 that provides presence information indicating user states. A plurality of client devices are associated with one user. The client devices may be computers such as desktop personal computers (desktop PCs) or laptop personal computers (laptop PCs). The client devices may be electronic apparatuses such as tablet devices or mobile phones.

The client devices 3, 3a, 3b, and 3c are carried and transported by their user to various areas (such as, for example, an internal area, external area, internal first site, and internal second site). The client devices 3, 3a, 3b, and 3c are able to communicate with the information processing device 1 via either network 2 or 2a.

For example, in the status depicted in FIG. 1, the information processing device 1 is able to communicate with client devices 3, 3a, and 3b via the network 2. The information processing device 1 is able to communicate with the client device 3c via the network 2a. The client devices 3 and 3a are used by user X. The client devices 3b and 3c are used by user Y.

The information processing device 1 includes a storage unit 1a and a calculation unit 1b. The storage unit is may be a storage device such as a random access memory (RAM) or hard disk drive (HDD). The calculation unit 1b may be a processor such as a central processing unit (CPU) or a field programmable gate array (FPGA). Information processing according to the first embodiment may be achieved by causing the calculation unit 1b to execute a program stored in the storage unit 1a.

The storage unit is stores information 4 that indicates the correspondence between users and client devices. The information 4 includes, for example, the correspondence between user X and the client devices 3 and 3a. The identification information of the client device 3 is “X1”. The identification information of the client device 3a is “X2”. The information 4 also includes the correspondence between user Y and the client devices 3b and 3c. The identification information of the client device 3b is “Y1”. The identification information of the client device 3c is “Y2”.

The calculation unit 1b collects, from the client devices 3, 3a, 3b, and 3c, information indicating which of the network 2 and 2a is accessible from each of the client devices 3, 3a, 3b, and 3c. For example, this information includes identification information of the client devices. For example, the calculation unit 1b collects information indicating that the network 2 is accessible from the client devices 3, 3a, and 3b. The calculation unit 1b also collects information indicating that the network 2a is accessible from the client device 3c. The calculation unit 1b identifies combination of information collected from a plurality of client devices associated with a user according to the information 4, and generates presence information including information indicating the locations of the user based on the combination. For example, the calculation unit 1b compares the identification information of client devices included in the collected information with the registered content of the information 4 to recognize the plurality of client devices associated with a user.

For example, the calculation unit 1b identifies a first combination of information collected from the client devices 3 and 3a associated with user X with reference to the information 4. The calculation unit 1b determines location L1 of user X based on the first combination. The calculation unit 1b generates presence information including location L1 of user X (for example, a record of user X in the information 4). For example, location L1 indicates a first area 5.

For example, the calculation unit 1b identifies a second combination of information collected from the client devices 3b and 3c associated with user Y with reference to the information 4. The calculation unit 1b determines location L2 of user Y based on the second combination. The calculation unit 1b generates presence information including location L2 of user Y (for example, a record of user Y in the information 4). For example, location L2 indicates a second area 6.

The calculation unit 1b may determine the locations of the users as described below, based on combination of information collected from the client devices 3, 3a, 3b, and 3c. For example, when the client devices that are associated with a user and able to communicate with the information processing device 1 are able to access the network corresponding to the area (for example, internal area or first internal site) in which the user is located at the normal time, the location of the user is set to this area.

On the other hand, when at least one of the client devices that are associated with a user and able to communicate with the information processing device 1 are able to access the network corresponding to another area (for example, external area or second internal site) other than the area in which the user is located at the normal time, the location of the user is set to the other area.

More specifically, the first area 5 is assumed to be an area in which user X and user Y are located at the normal time, for example. The second area 6 is assumed to be the other area described above. In this case, the client devices 3 and 3a are able to communicate with the information processing device 1 and both are able to access the network 2. The area corresponding to the network 2 is the first area 5. Accordingly, the calculation unit 1b determines the location of user X to be location L1. The client devices 3b and 3c are able to communicate with the information processing device 1. The client device 3b is able to access the network 2. The client device 3c is able to access the network 2a. The area corresponding to the network 2a is the second area 6. Accordingly, the calculation unit 1b determines the location of user Y to be location L2.

The calculation unit 1b may provide the generated presence information for the client devices 3, 3a, 3b, and 3c. For example, user X may confirm that user Y is located in the second area 6 by referencing the generated presence information using the client device 3.

In the information processing device 1, the calculation unit 1b collects, from the client devices 3, 3a, 3b, and 3c, information indicating which of the network 2 and 2a is accessible from each of the client devices 3, 3a, 3b, and 3c. The calculation unit 1b identifies the combination of information collected from the client devices 3 and 3a associated with user X using the information 4. The calculation unit 1b generates presence information including information indicating the location of user X based on the combination.

This may provide the location of a user appropriately. When, for example, one user uses a plurality of client devices, it may be difficult to grasp the location of the user appropriately only by reporting presence information for each of the client devices as in the related art. This is because the user does not necessarily carry all the plurality of client devices at any time. For example, user Y may carry and use the client device 3c in the second area 6 while leaving the client device 3b in the first area 5.

At this time, the information processing device 1 may separately provide presence information indicating that user Y is seated or busy through each of the client devices 3b and 3c. However, user X does not easily determine the location of user Y appropriately based on the presence information that only separately provides each of the states of the client devices 3b and 3c.

Accordingly, for example, the information processing device 1 collects information indicating which network is accessible from a plurality of client devices associated with one user and, based on the combination thereof, generates presence information including information indicating the location of the one user. Each of the users appropriately grasps the locations of other users using the presence information provided by the information processing device 1 through the client device that the user uses.

Travel information indicating the travel method of a user may be obtained by detecting the acceleration pattern of the user through the client device. When, for example, a client device has an acceleration sensor, the acceleration pattern of the user who travels while carrying the client device may be detected. Then, the information processing device 1 collects the travel information from the client device and generates presence information including the travel information for the user. For example, when the second area is an outdoor area, the user may take various travel methods (such as walk, train, and automobile). In this case, if another user is able to grasp the user's travel method from presence information, the other user is able to grasp the user's location and state in detail.

In addition, destination information indicating that the user is located at the destination registered in a client device or around the destination may be obtained by detecting the user's location through the client device. When the client has a global positioning system communication (GPS) unit, the location of the user who travels while carrying the client device may be detected. Then, the information processing device 1 collects destination information from the client device and generates, for the user, presence information including destination information. For example, the user may sometimes visit a customer to have a meeting. In such a case, if other users are able to know that the user is located at the customer's place or around the customer's place based on the presence information, they are able to grasp the location and state of the user in detail.

As described above, if the travel status and presence of the user around the destination are found, other users are easily able to determine, for example, whether to make contact with the user or how long to put the contact on hold. In addition, other users are easily able to determine what method (such as, for example, telephone, text chat, short messages, or email) to use for making contact. For example, a call in a train may be against hospitality, or a call or chat is difficult during a travel with an automobile because the user may be in operation. When the user visits a customer, a call or chat may also be difficult. As described above, other users are easily able to select an appropriate contact method according to the user's status.

Alternatively, collection of information from the plurality of client devices may be shared among a plurality of information processing devices including the information processing device 1. For example, the information processing device 1 may collect information from a client device capable of accessing the network 2 and another information processing device may collect information from a client device capable of accessing the network 2a. Then, the information (information indicating that which network is accessible from each of the plurality client devices) collected by both information processing devices may be synchronized to generate presence information and the plurality client devices may be provided with the generated information. This allows load on collection of information to be distributed between both the information processing devices.

For example, there is a case where access from an external network (first site network) to an internal network (second site network) has to be prohibited for security purposes. In such a case, if an information processing device is disposed in each of the networks, the location of the user may be provided appropriately by collecting information from a client device accessible to any one of the networks.

### Second Embodiment

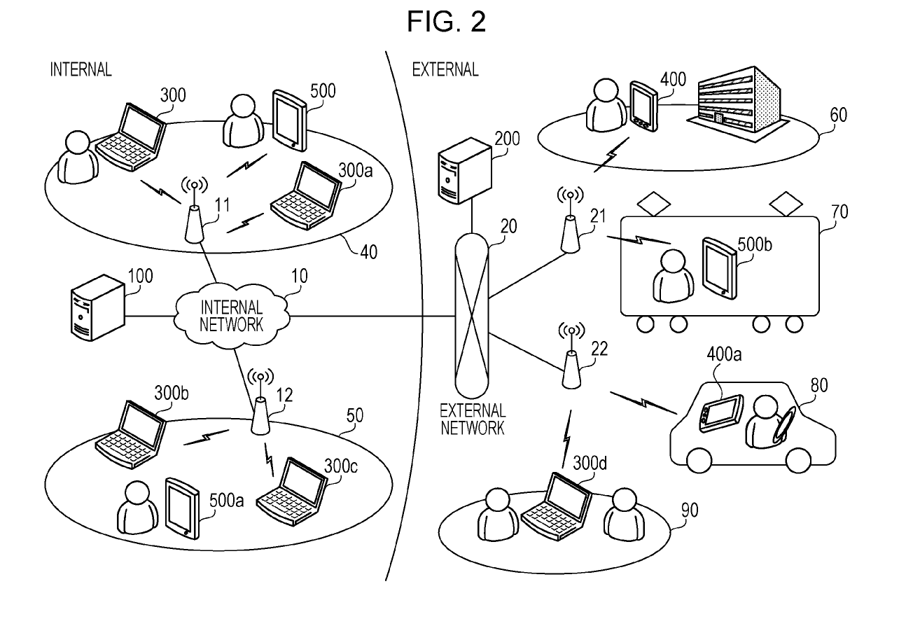

FIG. 2 is a diagram illustrating an example of a presence management system, according to a second embodiment. The presence management system according to the second embodiment includes an internal server 100, an external server 200, PCs 300, 300a, 300b, 300c, and 300d, mobile phones 400 and 400a, and tablet devices 500, 500a, and 500b. In the following description, the PCs 300, 300a, 300b, 300c, and 300d, the mobile phones 400 and 400a, and the tablet devices 500, 500a, and 500b may be collectively referred to as clients.

The internal server 100 is connected to the internal network 10. The internal network 10 is, for example, a local area network (LAN) internally constructed. The internal network 10 may be a network that interconnects local area networks constructed in sites 40 and 50, which are geographically separated from each other. The external server 200 is connected to an external network 20. The external network 20 is a wide area network (WAN) such as the Internet.

The internal network 10 and the external network 20 are connected so that they are able to communicate with each other. However, communication between the internal network 10 and the external network 20 is restricted by a device such as a firewall or so on disposed in the internal network 10. For example, it is restricted to predetermined communications such as a communication predetermined between the internal server 100 and the external server 200 and a communication for HyperText Transfer Protocol (HTTP) access from an internal network. The restriction prevents leakage of confidential information caused by illegal access to internal information.

The PCs 300 and 300a and the tablet device 500 are able to access the internal network 10 via an access point (AP) 11. The PCs 300b and 300c and the tablet device 500a are able to access the internal network 10 via an AP 12. The APs 11 and 12 are wireless routers that communicate with clients by wireless. However, the APs 11 and 12 may be connected to clients by wire. The AP 11, which is disposed in the site 40, may relay communication toward the internal network 10 via the LAN constructed in the site 40. The AP 12, which is disposed in the site 50, may relay communication toward the internal network 10 via the LAN constructed in the site 50.

The mobile phone 400 and a tablet device 500b are able to access the external network 20 via an AP 21. The PC 300d and the mobile phone 400a are able to access the external network 20 via an AP 22. The APs 21 and 22 are wireless routers that communicate with clients by wireless. The AP 21 and 22 may be wireless base stations that communicate with the external network 20 via a mobile communication network. However, the APs 21 and 22 may be connected to clients by wire.

The internal server 100 is a server computer that provides presence information indicating the seating statuses of a plurality of users. The internal server 100 collects information mainly from internal clients and provides presence information based on the collected information for internal and external clients in corporation with the external server 200.

The external server 200 is a server computer that provides presence information. The external server 200 collects information mainly from external clients and provides presence information based on the collected information for internal and external clients in corporation with the internal server 100. The external server 200 may be disposed in a data center. In this case, the external server 200 is able to communicate with the external network 20 via a network in the data center.

The PCs 300, 300a, 300b, 300c, and 300d are client computers used by users. The PCs 300, 300a, 300b, 300c, and 300d may be of desktop type or laptop type. The mobile phones 400 and 400a are electronic devices used by users. The mobile phones 400 and 400a may be smart phones. The tablet devices 500, 500a, and 500b are electronic devices used by users. The tablet devices 500, 500a, and 500b may be tablet PCs.

For example, clients are carried and transported by users to internal and external areas. For example, in the status in FIG. 2, the PCs 300 and 300a and the tablet device 500 are located in the internal site 40. The PCs 300b and 300c and the tablet device 500a are located in the internal site 50. The PC 300d and the tablet device 500b are located in an external area. The mobile phone 400 is located in a town 60. The user of the mobile phone 400 is walking. The tablet device 500b is located in a train 70. The user of the tablet device 500b is travelling by train. The mobile phone 400a is located in an automobile 80. The user of the mobile phone 400a is driving an automobile. The PC 300d is located in a customer place 90. The user of the PC 300d is having a meeting with a customer. As described above, the clients are placed in various statuses in internal and external areas.

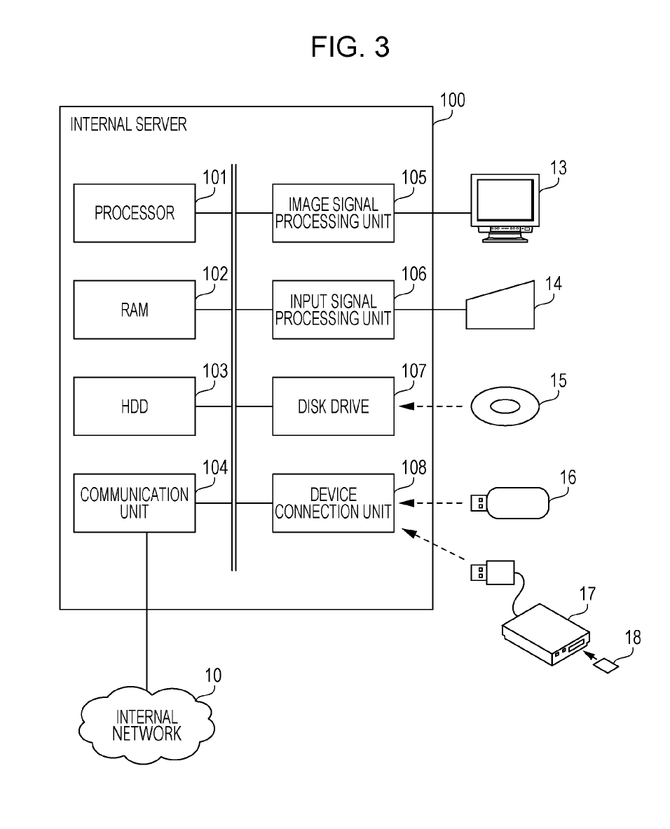

FIG. 3 is a diagram illustrating an example of a hardware configuration of an internal server, according to an embodiment. The internal server 100 includes a processor 101, a RAM 102, a HDD 103, a communication unit 104, an image signal processing unit 105, an input signal processing unit 106, a disk drive 107, and a device connection unit 108. These units are connected to a bus of the internal server 100.

The processor 101 controls the information processing of the internal server 100. The processor 101 is, for example, a CPU, micro processing unit (MPU), digital signal processor (DSP), application specific integrated circuit (ASIC), FPGA, programmable logic device (PLD), or so on. The processor 101 may be a plurality of processors. The processor 101 may be a combination of two or more of a CPU, MPU, DSP, ASIC, FPGA, and PLD.

The RAM 102 is the main storage device of the internal server 100. The RAM 102 temporarily stores at least a part of programs of an operating system (OS) and application programs executed by the processor 101. The RAM 102 also stores various types of data used for processing performed by the processor 101.

The HDD 103 is an auxiliary storage device of the internal server 100. The HDD 103 writes data to and reads data from a built-in magnetic disk magnetically. The HDD 103 stores OS programs, application programs, and various types of data. The internal server 100 may include another auxiliary storage device such as a flash memory or solid state drive (SSD) or may include a plurality of auxiliary storage devices.

The communication unit 104 is an interface that enables wireless communicates with other computers via the internal network 10. The communication unit 104 may be a wired interface.

The image signal processing unit 105 outputs an image to a display 13 connected to the internal server 100 according to an instruction from the processor 101. The display 13 may be a cathode ray tube (CRT) display or liquid crystal display.

The input signal processing unit 106 obtains an input signal from an input device 14 connected to the internal server 100 and outputs the obtained signal to the processor 101. The input device 14 may be, for example, a keyboard or a pointing device such as a mouse or touch panel.

The disk drive 107 is a driving apparatus that reads programs and data recorded in an optical disc 15 using laser light or so on. The optical disc 15 may be, for example, a digital versatile disc (DVD), DVD-RAM, compact disc read only memory (CD-ROM), CD-R (recordable)/RW (rewritable), or so on. For example, the disk drive 107 stores programs and data read from the optical disc 15, in the RAM 102 or the HDD 103, according to an instruction from the processor 101.

The device connection unit 108 is a communication interface used to connect peripheral devices to the internal server 100. For example, a memory unit 16 or reader writer unit 17 may be connected to the device connection unit 108. The memory unit 16 is a storage medium having the function of communicating with the device connection unit 108. The reader writer unit 17 writes data to or reads data from a memory card 18. The memory card 18 is a card type recording medium. For example, the device connection unit 108 stores programs and data read from the memory unit 16 or the memory card 18, in the RAM 102 or the HDD 103, according to an instruction from the processor 101.

The external server 200 and PCs 300, 300a, 300b, 300c, and 300d may also be implemented using hardware similar to that of the internal server 100.

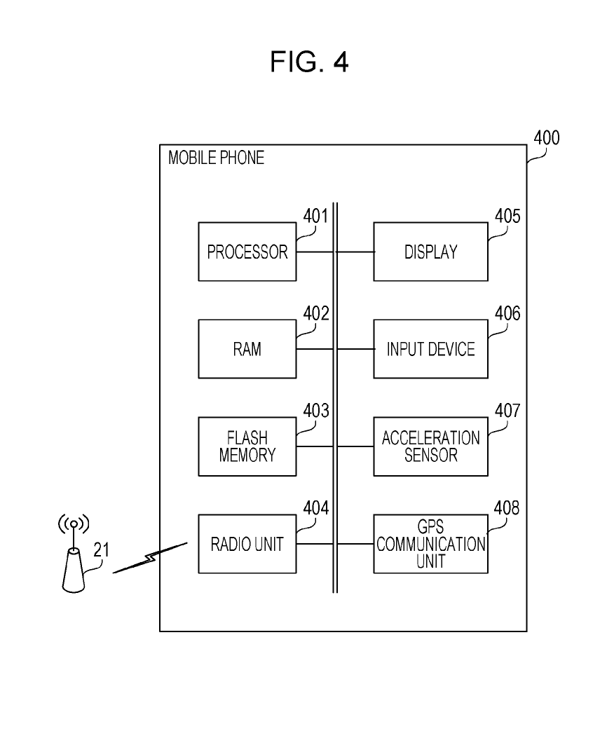

FIG. 4 is a diagram illustrating an example of a hardware configuration of a mobile phone, according to an embodiment. The mobile phone 400 has a processor 401, a RAM 402, a flash memory 403, a radio unit 404, a display 405, an input device 406, an acceleration sensor 407, and a GPS communication unit 408. The individual units are connected to a bus of the mobile phone 400.

The processor 401 controls the information processing of the mobile phone 400. The processor 401 is, for example, a CPU, MPU, DSP, ASIC, FPGA, PLD, or so on. The processor 401 may be a plurality of processors. The processor 401 may be a combination of two or more of a CPU, MPU, DSP, ASIC, FPGA, and PLD.

The RAM 402 is the main storage device of the mobile phone 400. The RAM 402 temporarily stores at least a part of operating system (OS) programs and application programs executed by the processor 401. The RAM 402 also stores various types of data used for processing performed by the processor 401.

The HDD 403 is an auxiliary storage device of the mobile phone 400. The flash memory 403 stores OS programs, application programs, and various types of data. The flash memory 403 may be a portable recording medium detachable to the mobile phone 400.

The radio unit 404 may be an interface that wireless communicates with the AP 21. In a case where the AP 21 is a wireless router, the radio unit 404 is a wireless LAN interface. For example, in a case where the AP 21 is a wireless base station, the radio unit 404 is a wireless interface for mobile communication. The mobile phone 400 may include wireless interfaces for both wireless LAN and mobile communication. The mobile phone 400 may include a wired communication interface in addition to or in place of the radio unit 404 so as to be connected to the AP 21.

The display 405 outputs an image according to an instruction from the processor 401. The display 405 is, for example, a liquid crystal display or organic electroluminescence display.

The input device 406 outputs the input signal to the processor 401. The input device 406 is, for example, a button, switch, touch panel, or so on.

The acceleration sensor 407 is a sensor device that detects acceleration in the directions of the two horizontal axes or in the vertical direction.

The GPS communication unit 408 is a communication device that communicates with GPS satellites or wireless base stations to obtain its current position. The GPS communication unit 408 may measure, for example, the latitude, longitude, altitude, and so on as information indicating the current position.

The mobile phone 400 includes a speaker and microphone for a call in addition to the above units. The mobile phone 400a and the tablet devices 500, 500a, and 500b may be implemented using hardware similar to that of the mobile phone 400. The PCs 300, 300a, 300b, 300c, and 300d may include an acceleration sensor or GPS communication unit in addition to the hardware illustrated in FIG. 3. As illustrated in FIG. 4, the PCs 300, 300a, 300b, 300c, and 300d may include a display or input device.

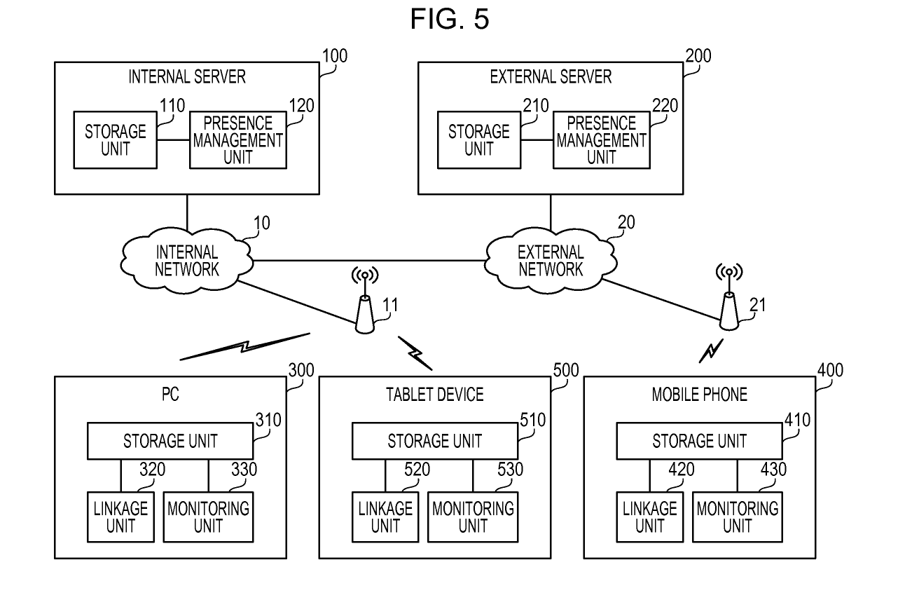

FIG. 5 is a diagram illustrating an example of software of a presence management system, according to an embodiment. Parts or all of the units depicted in FIG. 5 may be modules of a program executed by the processor included in each unit. The internal server 100 includes a storage unit 110 and a presence management unit 120.

The storage unit 110 stores various types of data used for processing performed by the presence management unit 120. The information stored in the storage unit 110 includes an account management table, a group management table, and a presence management table.

The account management table manages the correspondence between users and clients owned by the users and so on. The group management table manages the correspondence between users and groups. The presence management table manages presence information of users.

The presence management unit 120 manages the presence of users based on information stored in the storage unit 110. The presence management unit 120 collects information of internal clients, generates presence information for each user, and registers the generated presence information in the presence management table stored in the storage unit 110. The presence management unit 120 provides the presence information registered in the presence management table for each client in corporation with the external server 200.

When a user has a plurality of clients, the presence management unit 120 generates the presence information of the user, based on combination of information obtained from the plurality of clients. The presence management unit 120 may obtain the presence information of an external user from the external server 200 and provide the obtained information for internal clients. In addition, the presence management unit 120 may provide the presence information of internal users for the external server 200.

The external server 200 includes a storage unit 210 and a presence management unit 220. The storage unit 210 stores various types of information used for processing performed by the presence management unit 220. The information stored in the storage unit 210 is similar to that in the storage unit 110. That is, the storage unit 210 also stores an account management table, a group management table, and a presence management table. The presence management units 120 and 220 operate in corporation with each other to synchronize the registered content of the account management tables and the group management tables of the storage units 110 and 210 when these tables are updated. The presence management table stored in the storage unit 210 is different from the presence management table stored in the storage unit 110 in that the presence management table in the storage unit 210 stores the presence information of users who are primarily located externally.

The presence management unit 220 manages the presence information of users based on information stored in the storage unit 210. The presence management unit 220 collects information of external clients, generates presence information for each user, and registers the generated presence information in the presence management table stored in the storage unit 210. The presence management unit 220 provides the presence information registered in the presence management table for each client in corporation with the internal server 100.

When a user has a plurality of clients, the presence management unit 220 generates the presence information of the user, based on combination of information obtained from the plurality of clients, in a manner similar to the presence management unit 120. The presence management unit 220 may obtain the presence information of an internal user from the internal server 100 and provide the obtained information for external clients. In addition, the presence management unit 220 may provide the presence information of external users for the internal server 100.

The PC 300 includes a storage unit 310, a linkage unit 320, and a monitoring unit 330. The storage unit 310 stores various types of information used for processing performed by the linkage unit 320 and the monitoring unit 330. The information stored in the storage unit 310 includes a group management table, acceleration pattern information, A destination management table, a state management table, and a member presence table.

The group management table contains a list (group) of users registered by the users. A plurality of groups may be registered in the group management table. The acceleration pattern information contains a pattern that depends on the travel method corresponding to acceleration detected by an acceleration sensor included in the PC 300. The destination management table a table that contains destination places (latitude and longitude) to which users frequently visit and that is used when the PC 300 has the GPS communication unit. The state management table manages the states of clients. The member presence table contains the presence information of users (group members) included in the group selected by users from among groups in the group management table.

When the monitoring unit 330 updates the content of the state management table, the linkage unit 320 notifies the internal server 100 (the external server 200 when the PC 300 is located externally) of the updated content. When a user selects any group in the group management table, the linkage unit 320 requests the presence information of the group members of this group from the internal server 100 (the external server 200 when the PC 300 is located externally). The linkage unit 320 obtains the presence information of the group members from the internal server 100 (or the external server 200) and displays the presence information of the group members on a display device such as a display.

The storage unit 310 stores various types of information used by the linkage unit 320 to communicate with the internal server 100 or the external server 200. This information includes, for example, the uniform resource locators (URLs) and Internet protocol (IP) addresses of the internal server 100 and the external server 200 and so on. The information also includes the cryptographic key, the network name (SSID: service set identifier), and so on used to communicate with the APs 11 and 12.

The monitoring unit 330 monitors the state of the PC 300 and rewrites the state management table stored in the storage unit 310. For example, the monitoring unit 330 monitors states as described below:

(1) Whether it is possible to access an internal or external network, where this monitoring is performed based on accessibility to the APs 11 and 12 or accessibility to the APs 21 and 22;

(2) Whether no-operation state continues for a predetermined period of time, where this monitoring is performed by using a timer to measure the time elapsed since operation has been last accepted;

(3) What travel status is applied to the user when the PC 300 is externally located, where this monitoring is performed by the acceleration detection pattern by an acceleration sensor;

(4) Whether the current location is in the vicinity of the predetermined destination when the PC 300 is externally located, where this monitoring is performed based on the current location information obtained by the GPS communication unit and the destination management table stored in the storage unit 310;

(5) Whether a call is made using TV conference software, where this monitoring is performed based on the use status of TV conference software in the PC 300; and

(6) Whether the user specifies predetermined information indicating the user state (such as the busy state), where this monitoring is performed by monitoring the operation input by the user.

The mobile phone 400 includes a storage unit 410, a linkage unit 420, and a monitoring unit 430. The tablet unit 500 includes a storage unit 510, a linkage unit 520, and a monitoring unit 530. The information stored in the storage units 410 and 510 is similar to the information stored in the storage unit 310.

The linkage units 420 and 520 have the same function as the linkage unit 320. In the system according to the second embodiment, access to main internal servers including the internal server 100 by the mobile phones 400 and 400a is prohibited for security purposes. Accordingly, linkage unit 420 is not allowed to access the internal server 100 via the APs 11 and 12.

The monitoring units 430 and 530 have the same function as the monitoring unit 330. More specifically, they monitor the states described in (1) to (6) above, in a manner similar to the monitoring unit 330.

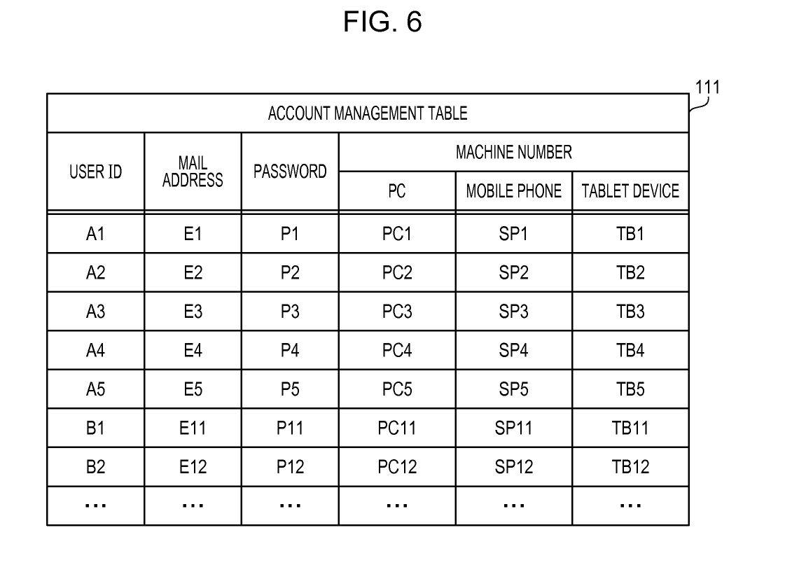

FIG. 6 is a diagram illustrating an example of an account management table, according to an embodiment. An account management table 111 is stored in the storage unit 110 in advance. The account management table 111 includes, as items, a user ID (identifier), a mail address, a password, and machine numbers (for PC, mobile phone, and tablet device).

The user ID item contains the user ID of a user. The mail address item contains the mail address of a user. For example, the user receives and references the mail sent to the mail address from the internal server 100 or another mail server, by using predetermined mail software executed by each client. The password item contains a password used for user authentication. For example, user authentication is performed automatically when each client starts accessing the internal server 100 or performed by causing the user to input the user ID and password. The machine number item contains the machine number of a client. In the second embodiment, a PC, mobile phone, and tablet device are assumed as clients. Accordingly, the machine numbers of clients owned by the user are registered.

For example, the account management table 111 contains information with a user ID of “A1”, a mail address of “E1”, a password of “P1”, a machine number (for PC) of “PC1”, a machine number (for mobile phone) of “SP1”, and a machine number (for tablet) of “TB1”.

That is, user “A1” has a mail address of “E1” and an authentication password of “P1”. It also indicates that the PC owned by user “A1” has a machine number of “PC1”, the mobile phone owned by user “A1” has a machine number of “SP1”, and the tablet device owned by user “A1” has a machine number of “TB1”.

In addition, the account management table 111 contains information with a user ID of “A2”, a mail address of “E2”, a password of “P2”, a machine number (for PC) of “PC2”, a machine number (for mobile phone) of “SP2”, and a machine number (for tablet) of “TB2”.

That is, user “A2” has a mail address of “E2” and an authentication password of “P2”. It also indicates that the PC owned by user “A2” has a machine number of “PC2”, the mobile phone owned by user “A2” has a machine number of “SP2”, and the tablet device owned by user “A2” has a machine number of “TB2”.

The machine number is associated with each of the addresses of the clients. For example, the presence management unit 120 may store the correspondence between machine numbers and the IP addresses of accessed clients in the storage unit 110 for communication with the clients.

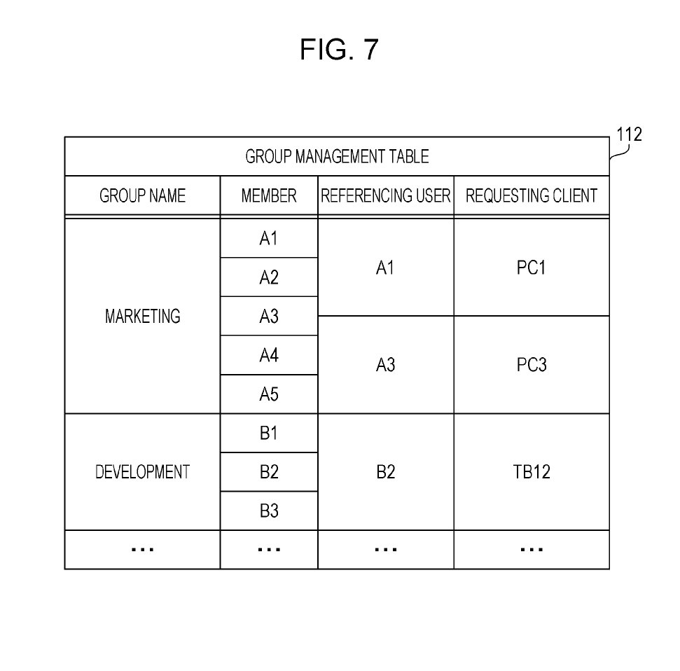

FIG. 7 is a diagram illustrating an example of a group management table, according to an embodiment. A group management table 112 is stored in the storage unit 110 in advance. The group management table 112 includes; as items, a group name, a member, a referencing user, and a requesting client.

The group name item contains the name of a group. The member item contains the user ID of a group member. The referencing user item contains the user ID of a user who is referencing the presence information of the group. The requesting client item contains the machine number of a client used by the user to reference present information.

For example, the group management table 112 contains information with a group name of “MARKETING”, members of “A1”, “A2”, “A3”, “A4”, and “A5”, a referencing user of “A1”, and a requesting client of “PC1”. That is, the group members of the “MARKETING” group are “A1”, “A2”, “A3”, “A4”, and “A5”. It also indicates that the user with a user ID of “A1” is referencing the presence information of the group members of the group using the client with a machine number of “PC1”.

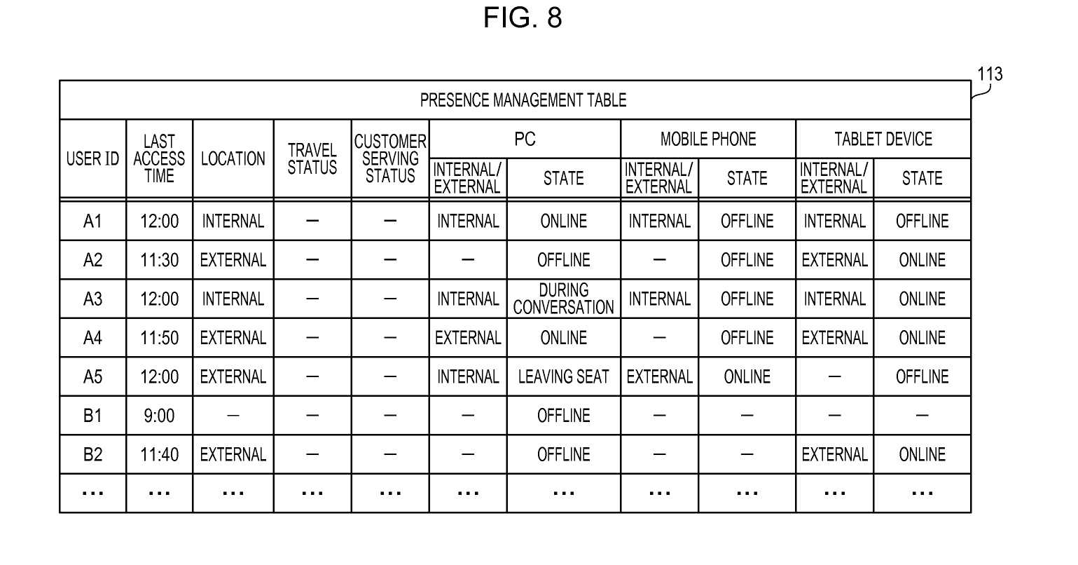

FIG. 8 is a diagram illustrating an example of a presence management table of an internal server, according to an embodiment. A presence management table 113 is stored in the storage unit 110 in advance. The presence management table 113 contains, as items, a user ID, a last access time, a location, a travel status, a customer serving status, a PC internal/external, a PC state, a mobile phone internal/external, a mobile phone state, a tablet device internal/external, and a tablet state.

The user ID item contains a user ID. The last access time item contains the time at which presence information has been last updated. The location item contains information indicating the location of the user. For example, the location item contains “INTERNAL” or “EXTERNAL”. “INTERNAL” indicates that the user is located internally. “EXTERNAL” indicates that the user is located externally. The symbol “−” indicates that the client is not used. For example, the client is powered off.

The travel status item contains information indicating the travel status of the user. “SEATING”, “WALK”, “TRAIN”, “AUTOMOBILE”, or “OTHERS” is registered in the travel status item. “SEATING” indicates that the user sits on the seat. “WALK” indicates that the user is walking. “TRAIN” indicates that the user is travelling with a train. “AUTOMOBILE” indicates that the user is travelling with an automobile. “OTHERS” indicates that the user is in a state other than “SEATING”, “WALK”, “TRAIN”, and “AUTOMOBILE”. The symbol “−” indicates that the travel status of the user is not monitored.

The customer serving status item contains information (corresponding to the destination information in the first embodiment) indicating whether the user is serving a customer. When the customer serving status item is “SERVING”, the user is serving a customer. The symbol “−” indicates that the user is serving no customer.

The PC internal/external item contains information indicating whether the PC is located internally or externally. “INTERNAL” or “EXTERNAL” is registered in the internal/external item. “INTERNAL” indicates that the PC is located internally. “EXTERNAL” indicates that the PC is located externally. The symbol “−” indicates that there is no setting. No setting is applied when, for example, the power to the PC is off, there is no connection to a network, or the user has no PC.

The PC state item contains information indicating the PC state and the user state. “ONLINE”, “OFFLINE”, “DURING CALL”, “BUSY”, or “LEAVING SEAT” is registered in the PC state item. “ONLINE” indicates that the user is working with the PC. “OFFLINE” indicates that the power of the PC is off. “DURING CALL” indicates that the user is making a call with TV conference software. “BUSY” indicates that the user is busy (“BUSY” is registered when the user performs operation input to the PC). “LEAVING SEAT” indicates that the use has left his seat in the online state. The symbol “−” indicates that the user has no PC.

The mobile phone internal/external item contains information indicating whether the mobile phone is located internally or externally. “INTERNAL” or “EXTERNAL” is registered in the mobile phone internal/external item. “INTERNAL” indicates that the mobile phone is located internally. “EXTERNAL” indicates that the mobile phone is located externally. The symbol “−” indicates that the mobile phone is powered off or the user has no mobile phone.

The mobile phone state item contains information indicating whether the power of the mobile phone is on or off. “ONLINE” or “OFFLINE” is registered in the mobile phone state item. “ONLINE” indicates that the user is using the mobile phone. “OFFLINE” indicates that the power of the PC is off. The symbol “−” indicates that the user has no mobile phone.

The tablet device internal/external item contains information indicating whether the tablet is located internally or externally. “INTERNAL” or “EXTERNAL” is registered in the tablet device internal/external item. “INTERNAL” indicates that the tablet is located internally. “EXTERNAL” indicates that the tablet is located externally. The symbol “−” indicates that the tablet is powered off or the user has no tablet.

The tablet device state item contains information indicating the tablet device state and the user state. “ONLINE”, “OFFLINE”, “DURING CALL”, “BUSY”, or “LEAVING SEAT” is registered in the tablet state item. “ONLINE” indicates that the user is working with the tablet device. “OFFLINE” indicates that the power of the tablet device is off. “DURING CALL” indicates that the user is making a call with TV conference software. “BUSY” indicates that the user is busy (“BUSY” is registered when the user performs operation input to the tablet device). “LEAVING SEAT” indicates that the use has left his seat in the online state. The symbol “−” indicates that the user has no tablet device.

For example, the presence management table 113 contains information with a user ID of “A1”, a last access time of “12:00”, a location of “INTERNAL”, a travel status of “−”, a customer serving status of “−”, a PC internal/external of “INTERNAL”, a PC state of “ONLINE”, a mobile phone internal/external of “INTERNAL”, a mobile phone state of “ONLINE”, a tablet device internal/external of “INTERNAL”, and a tablet device state of “OFFLINE”.

That is, user “A1” is located internally. In addition, user “A1” is working with the PC (“ONLINE”), the power of the mobile phone is on (“ONLINE”), and the power of the tablet device is off (“OFFLINE”). In addition, the presence information of user “A1” was last updated at “12:00”.

For example, the presence management table 113 contains information with a user ID of “A2”, a last access time of “11:30”, a location of “EXTERNAL”, a travel status of “−”, a customer serving status of “−”, a PC internal/external of “−”, a PC state of “OFFLINE”, a mobile phone internal/external of “−”, a mobile phone state of “OFFLINE”, a tablet device internal/external of “EXTERNAL”, and a tablet device state of “ONLINE”.

That is, user “A2” is located externally. In addition, for user “A2”, the power of the PC if off (“OFFLINE”), the power of the mobile phone is off (“OFFLINE”), and the power of the tablet device is on (“ONLINE”). In addition, the presence information of user “A2” was last updated at “11:30”.

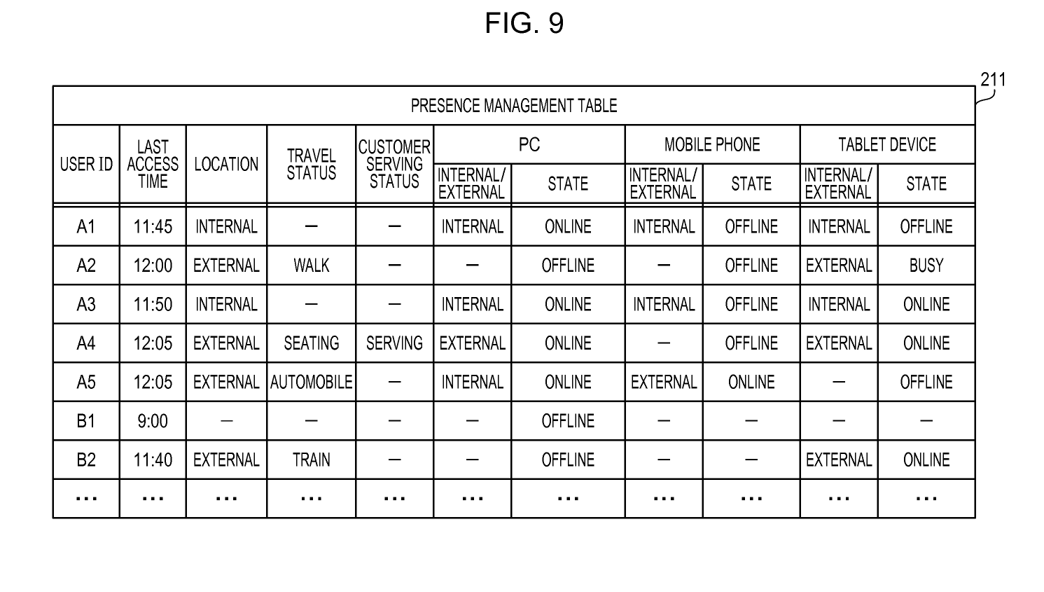

FIG. 9 is a diagram illustrating an example of a presence management table of an external server, according to an embodiment. A presence management table 211 is stored in the storage unit 210 in advance. The presence management table 211 contains, as items, a user ID, a last access time, a location, a travel status, a customer serving status, a PC internal/external, a mobile phone internal/external, a mobile phone internal/external, a tablet device internal/external, and a tablet state. The information registered in the items of the presence management table 211 is similar to that in the presence management table 113.

For example, the presence management table 211 contains information with a user ID of “A2”, a last access time of “12:00”, a location of “EXTERNAL”, a travel status of “WALK”, a customer serving status of “−”, a PC internal/external of “−”, a PC state of “OFFLINE”, a mobile phone internal/external of “−”, a mobile phone state of “OFFLINE”, a tablet device internal/external of “EXTERNAL”, and a tablet device state of “BUSY”.

That is, user “A2” is located externally and the travel status is “WALK”. In addition, the power to the PC of user “A2” is off (“OFFLINE”), the power to the mobile phone is off (“OFFLINE”), and the tablet device is in the “BUSY” state although the power to the tablet device is on. In addition, the presence information of user “A2” was last updated at “12:00”.

The registered presence information of user “A2” is partially different between the presence management table 113 and the presence management table 211. This is because this state is before synchronization between the presence management table 113 and the presence management table 211. For example, when receiving a presence information reference request, the internal server 100 and the external server 200 synchronize the presence management table 113 with the presence management table 211 in the range related to reference. That is, the internal server 100 manages the latest presence information of internal users. The external server 200 manages the latest presence information of external users. The internal server 100 and the external server 200 merge and provide the presence information managed by both servers.

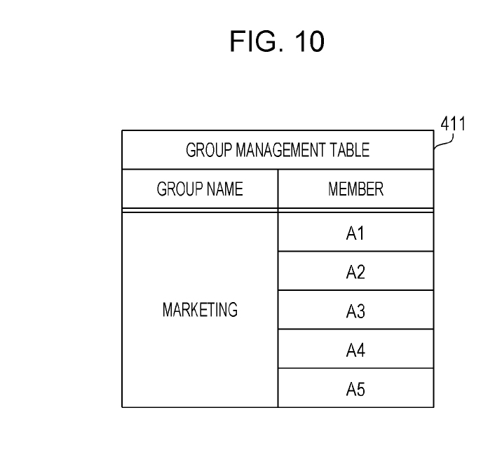

FIG. 10 is a diagram illustrating an example of a group management table, according to an embodiment. A group management table 411 is stored in the storage unit 410 in advance. The group management table 411 contains, as items, a group name and a member. The group name item contains the name of a group. The member item contains the user ID of a group member.

For example, the group management table 411 contains information with a group name of “MARKETING” and members of “A1”, “A2”, “A3”, “A4”, and “A5”. That is, the group members of the “MARKETING” group are “A1”, “A2”, “A3”, “A4”, and “A5”.

Here, the linkage unit 420 allows the user to update the group management table 411. The user may associate a list of desired users with a group name to register it in the group management table 411. Alternatively, a plurality of groups may be registered in the group management table 411. The linkage unit 420 may receive selection by a user in any group among the plurality of groups to request the internal server 100 or the external server 200 for presence information about the group.

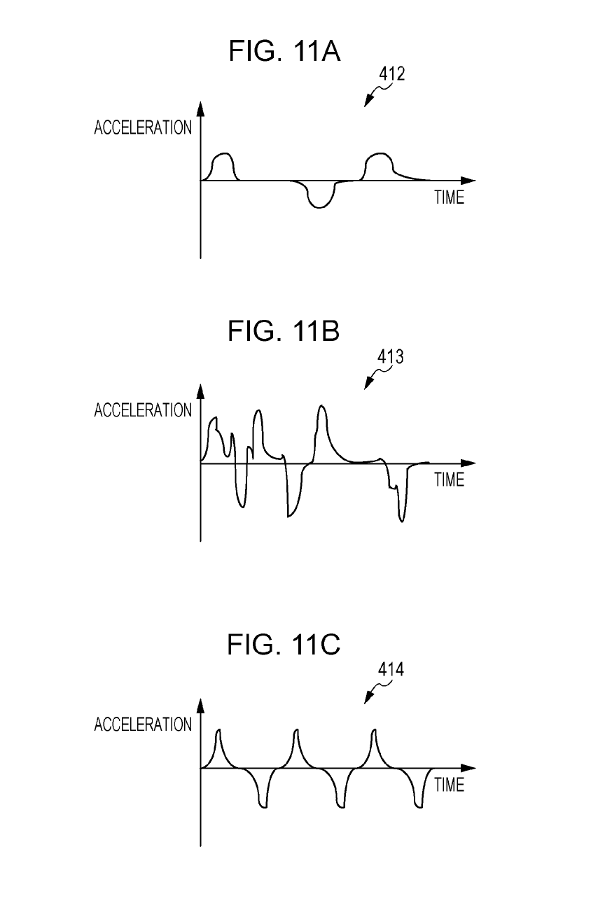

FIGS. 11A to 11C are diagrams illustrating examples of acceleration pattern information. FIG. 11A depicts an example of acceleration pattern information 412 during travel by train. FIG. 11B depicts an example of acceleration pattern information 413 during travel by automobile. FIG. 11C depicts an example of acceleration pattern information 414 during travel by foot. In the acceleration pattern information 412, 413, and 414, the acceleration patterns are depicted for each travel method with the magnitude of acceleration represented on the vertical axis and time represented on the horizontal axis. The acceleration pattern information 412, 413, and 414 are stored in the storage unit 410 in advance.

For example, the acceleration pattern information 412 has the following characteristics:

(1) The acceleration changes periodically; and

(2) The amplitude of the acceleration is uniform.

For example, the monitoring unit 430 determines the travel status of the user to be by train when (1) the acceleration changes periodically and (2) the amplitude of the acceleration is uniform as a result of the sampling of acceleration data obtained by the acceleration sensor 407.

For example, the acceleration pattern information 413 has the following characteristics:

(1) The acceleration does not change periodically;

(2) The amplitude of the acceleration is not uniform; and

(3) The amplitude of the acceleration is larger than that in train.

For example, the monitoring unit 430 determines the travel status of the user to be by automobile when (1) the acceleration does not change periodically, (2) the amplitude of the acceleration is not uniform, and (3) the amplitude of the acceleration is larger than that in train as a result of the sampling of acceleration data obtained by the acceleration sensor 407.

For example, the acceleration pattern information 414 has the following characteristics:

(1) The acceleration changes periodically;

(2) The amplitude of the acceleration is uniform; and

(3) The amplitude of the acceleration is small.

For example, the monitoring unit 430 determines the travel status of the user to be by foot when (1) the acceleration changes periodically, (2) the amplitude of the acceleration is uniform, and (3) the amplitude of the acceleration is small as a result of the sampling of acceleration data obtained by the acceleration sensor 407.

The monitoring unit 430 checks the accelerations of the three axes obtained by the acceleration sensor 407 against the acceleration patterns, as described below. For example, when the acceleration sensor 407 obtains the accelerations on the two axes (X-axis and Y-axis) on the horizontal plane and the vertical axis (Z-axis), the acceleration obtained for each axis is corrected in a predetermined method. Alternatively, for example, the acceleration of gravity (9.8 m/s²) is subtracted from the acceleration for the Z-axis. Then, the magnitude of acceleration is obtained from the accelerations of the three axes and plotted on the time axis. The monitoring unit 430 grasps the travel status of the user by checking the plotted points against the acceleration pattern information 412, 413, and 414.

The monitoring unit 430 obtains a linear equation using the least-square approach based on the acceleration pattern information 414. When the slope is determined to be 0 within a predetermined margin of error or time intervals at which accelerations with mutually reverse signs appear within error equal to or less than 0.5 seconds, the monitoring unit 430 may determine the status to be by foot.

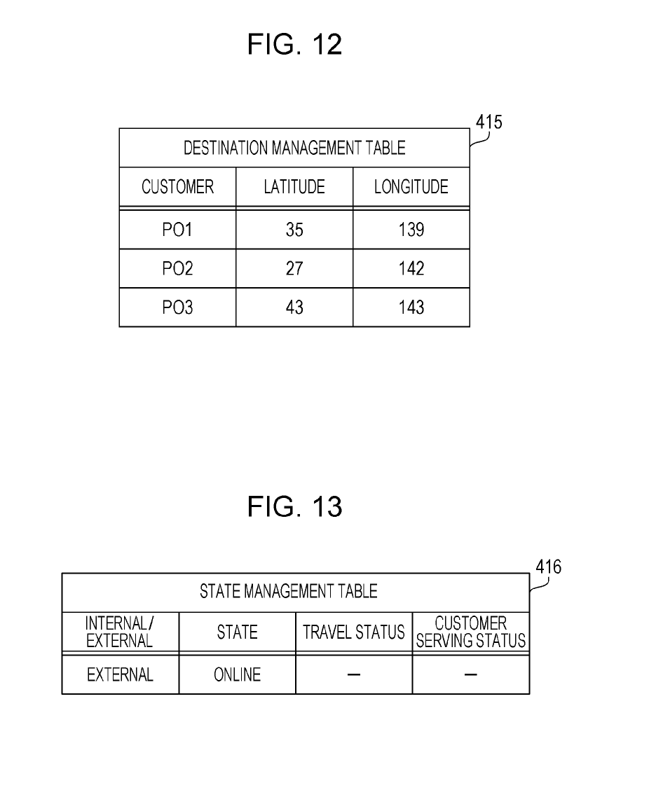

FIG. 12 is a diagram illustrating an example of a destination management table, according to an embodiment. A destination management table 415 is stored in the storage unit 410. The destination management table 415 includes, as items, a customer, a latitude, and a longitude.

The customer item contains the name of the customer of the user. The latitude item contains the latitude of the customer. The longitude item contains the longitude of the customer.

For example, this table contains information with a customer of “PO1”, a latitude of “35”, and a longitude of “139”. That is, the customer is “PO1”, the latitude of “PO1” is “35”, and the longitude of “PO1” is “139”.

The linkage unit 420 allows the user to register arbitrary information in the destination management table 415. For example, the user is able to register a plurality of frequent destinations in the destination management table 415.

FIG. 13 is a diagram illustrating an example of a state management table, according to an embodiment. A state management table 416 is stored in the storage unit 410. The state management table 416 includes, as items, an internal/external, a state, a travel status, and a customer serving status.

The internal/external item contains information indicating whether the mobile phone 400 is located internally or externally. The state item contains the state of the mobile phone 400. The travel status item contains the travel status of the user who owns the mobile phone 400. The customer serving status item contains information indicating whether the user is serving a customer.

For example, the state management table 416 contains information with an internal/external of “EXTERNAL”, a state of “ONLINE”, a travel status of “−”, and a customer serving status of “−”. That is, the mobile phone 400 is located externally in a state where communication is enabled.

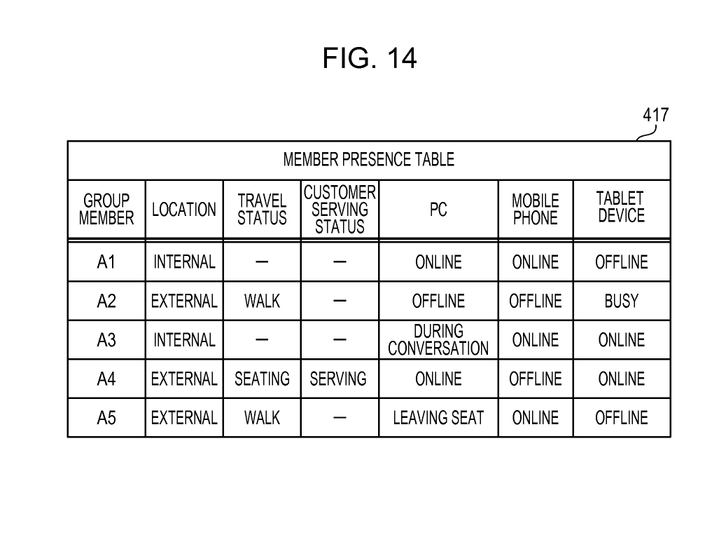

FIG. 14 is a diagram illustrating an example of a member presence table, according to an embodiment. A member presence table 417 is stored in the storage unit 410. The member presence table 417 includes, as items, a group member, a location, a travel status, a customer serving status, a PC, a mobile phone, and a tablet device.

The group member item contains the user IDs of group members. The location item contains locations. The travel status item contains information indicating the travel status. The customer serving status item contains information indicating whether the member is serving a customer. The PC item contains the state of the PC. The mobile phone item contains the state of the mobile phone. The tablet device item contains the state of the tablet device.

The member presence table 417 contains the latest present information of group members generated by merging information of the presence management table 113 with information of the presence management table 211.

For example, the member presence table 417 contains information with a group member is “A1”, a location of “INTERNAL”, a travel status of “−(hyphen)”, a customer serving status of “−”, a PC of “ONLINE”, a mobile phone of “ONLINE”, and a tablet device of “OFFLINE”.

That is, user “A1” is located internally. In addition, user “A1” is working with the PC (“ONLINE”), the power of the mobile phone is on (“ONLINE”), and the power of the tablet device is off (“OFFLINE”).

In addition, for example, the member presence table 417 contains information with a group member is “A4”, a location of “EXTERNAL”, a travel status of “SEATING”, a customer serving status of “SERVING”, a PC of “ONLINE”, a mobile phone of “OFFLINE”, and a tablet device of “ONLINE”. That is, user “A4” is located externally, sitting on the seat, and serving a customer. That is, for user “A4”, the PC is “ONLINE” externally, the power of the mobile phone is off (“OFFLINE”), the power of the tablet terminal is on (“ONLINE”).

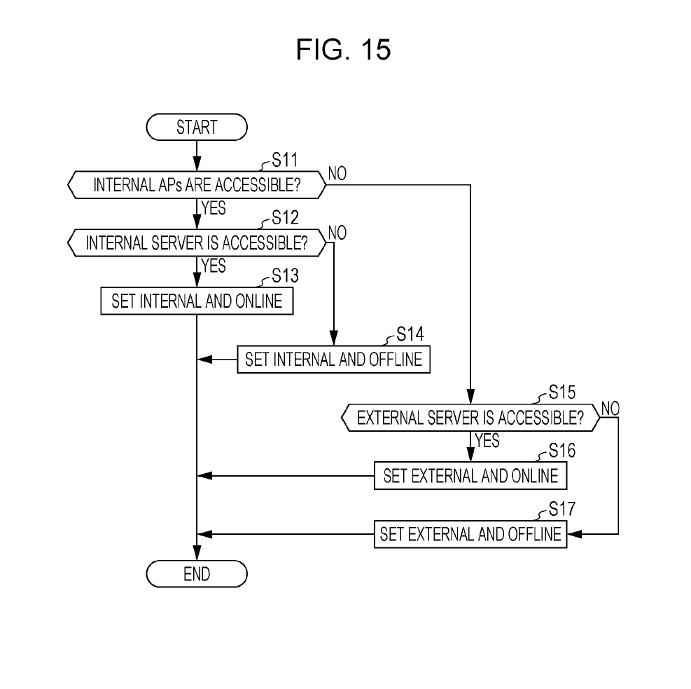

FIG. 15 is a diagram illustrating an example of an operational flowchart for presence determination through a client, according to an embodiment. The operations depicted in FIG. 15 will be described in order of the step number. In the following description, the PC 300 is taken as an example. However, a similar procedure is applicable to other clients.

(Step S11) The monitoring unit 330 determines whether the internal APs 11 and 12 are accessible. When the APs 11 and 12 are accessible, the processing proceeds to step S12. When the APs 11 and 12 are not accessible, the processing proceeds to step S15. The case where the APs 11 and 12 are accessible means that establishment of communication with the APs 11 and 12 is enabled. The case where the APs 11 and 12 are not accessible means that establishment of communication with the APs 11 and 12 is disabled because it is physically too distant from the APs 11 and 12 to transmit or receive electromagnetic waves of a predetermined strength.

(Step S12) The monitoring unit 330 determines whether the internal server 100 is accessible. When the server is accessible, the processing proceeds to step S13. When the server is not accessible, the processing proceeds to step S14. The case where the internal server 100 is accessible means that establishment of communication with the internal server 100 via the internal network 10 is enabled to transmit and receive data. The case where the internal server 100 is not accessible means that, for example, filtering is performed by the AP 11 or 12 or so on although establishment of communication with the AP 11 or 12 is enabled, thereby disabling access to the internal server 100 via the internal network 10 which is connected to the AP 11 or 12. For example, the AP 11 or 12 is able to restrict access to the internal server 100 by a client by verifying the client using a predetermined key or by performing filtering using the media access control (MAC) address. Access may be filtered by using a device other than the APs 11 and 12.

(Step S13) The monitoring unit 330 sets the internal/external item of the state management table stored in the storage unit 310 to “INTERNAL” and the state item to “ONLINE”. Then, the processing ends.

(Step S14) The monitoring unit 330 sets the internal/external item of the state management table to “INTERNAL” and the state item to “OFFLINE”. Then, the processing ends.

(Step S15) The monitoring unit 330 determines whether the external server 200 is accessible. When the external server 200 is accessible, the processing proceeds to step S16. When the external server 200 is not accessible, the processing proceeds to step S17. The case where the external server 200 is accessible means that establishment of communication with the external server 200 via the external network 20 is enabled to transmit and receive data. The case where the external server 200 is not accessible means that, for example, establishment of communication with the AP 21 or 22 is disabled because the PC 300 is physically too distant from the APs 21 and 22 to transmit or receive electromagnetic waves of a predetermined strength.

(Step S16) The monitoring unit 330 sets the internal/external item of the state management table to “EXTERNAL” and the state item to “ONLINE”. Then, the processing ends.

(Step S17) The monitoring unit 330 sets the state item of the state management table to “OFFLINE”. Then, the processing ends.

As described above, each client determines whether it is located internally or externally. The monitoring unit of each client executes the above procedure periodically. However, in the example according to the second embodiment, the mobile phone 400 is prohibited from accessing the internal server 100. Accordingly, in the processing by the monitoring unit 430, access is determined to be disabled in step S12. However, since the monitoring unit 430 is able to access the AP 11 in this case, the monitoring unit 430 is assumed to be able to access a predetermined internal network.

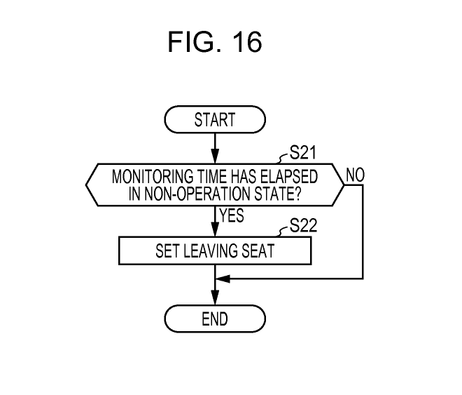

FIG. 16 is a diagram illustrating an example of an operational flowchart for monitoring operations performed by a client, according to an embodiment. The operations depicted in FIG. 16 will be described in order of the step number. In the following description, the PC 300 is taken as an example. However, a similar procedure is applicable to other clients.

(Step S21) The monitoring unit 330 determines whether the predetermined monitoring time has elapsed in a non-operation state. When the predetermined monitoring time has elapsed, the processing proceeds to step S22. When the predetermined monitoring time has not elapsed, the processing ends. The predetermined monitoring time may be five minutes, for example. For example, the monitoring unit 330 allows the user to change the predetermined monitoring time and stores the state in the storage unit 310.

(Step S22) The monitoring unit 330 sets the state item of the state management table stored in the storage unit 310 to “LEAVING SEAT”. Then, the processing ends.

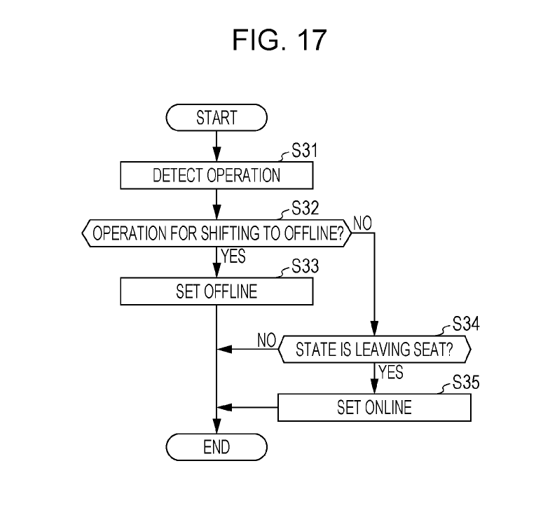

FIG. 17 is a diagram illustrating an example of an operational flowchart for detecting operations performed by a client, according to an embodiment. The operations depicted in FIG. 17 will be described in order of the step number. In the following description, the PC 300 is taken as an example. However, a similar procedure is applicable to other clients.

(Step S31) The monitoring unit 330 detects that an input operation has been performed via the PC 300 using a predetermined input device (such as, for example, a mouse or keyboard).

(Step S32) The monitoring unit 330 determines whether the input operation in step S31 is an operation for shifting to offline. An operation for shifting to offline is, for example, an operation for powering off the PC 300. When the operation is an operation for shifting to offline, the processing proceeds to step S33. When the operation is not an operation for shifting to offline, the processing proceeds to step S34.

(Step S33) The monitoring unit 330 sets the state item of the state management table stored in the storage unit 310 to “OFFLINE”. Then, the processing ends.

(Step S34) The monitoring unit 330 determines whether the state is “LEAVING SEAT” with reference to the state management table. When the state is “LEAVING SEAT”, the processing proceeds to step S35. When the state is not “LEAVING SEAT”, the processing ends.

(Step S35) The monitoring unit 330 sets the state item of the state management table to “ONLINE”. Then, the processing ends.

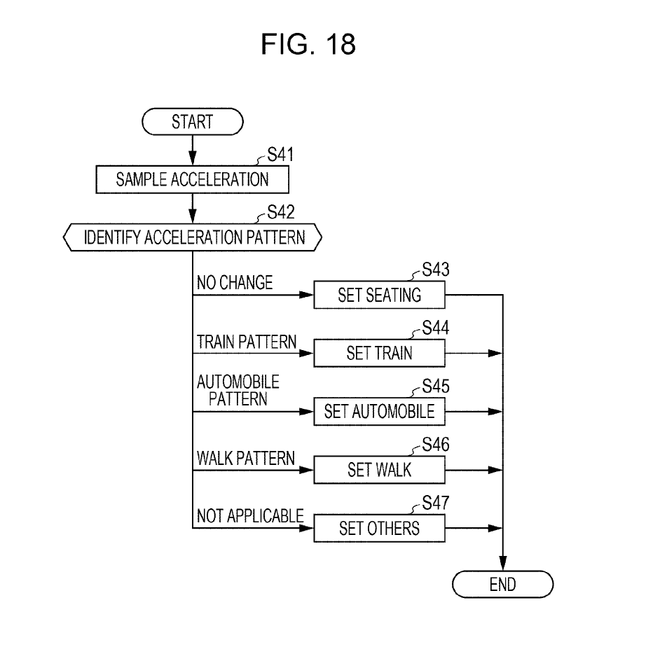

FIG. 18 is a diagram illustrating an example of an operational flowchart for determining a travel status of a client, according to an embodiment. The operations depicted in FIG. 18 will be described in order of the step number. In the following description, the mobile phone 400 is taken as an example. However, a similar procedure is applicable to other clients.

(Step S41) The monitoring unit 430 samples information on accelerations obtained by the acceleration sensor 407.

(Step S42) The monitoring unit 430 determines which travel method causes time variations of the magnitude of acceleration using the acceleration pattern information 412, 413, and 414 stored in the storage unit 410. When the acceleration does not change, the processing proceeds to step S43. When the variations correspond to the acceleration pattern information 412, the processing proceeds to step S44. When the variations correspond to the acceleration pattern information 413, the processing proceeds to step S45. When the variations correspond to the acceleration pattern information 414, the processing proceeds to step S46. When the variations correspond to no acceleration pattern information, the processing proceeds to step S47.

(Step S43) The monitoring unit 430 sets the travel status item of the state management table 416 stored in the storage unit 410 to “SEATING”. Then, the processing ends.

(Step S44) The monitoring unit 430 sets the travel status item of the state management table 416 to “TRAIN”. Then, the processing ends.

(Step S45) The monitoring unit 430 sets the travel status item of the state management table 416 to “AUTOMOBILE”. Then, the processing ends.

(Step S46) The monitoring unit 430 sets the travel status item of the state management table 416 to “WALK”. Then, the processing ends.

(Step S47) The monitoring unit 430 sets the travel status item of the state management table 416 to “OTHERS”. Then, the processing ends.

The monitoring unit 430 performs the determination of the travel status described above when the internal/external setting registered in the state management table 416 is “EXTERNAL”. When the internal/external setting registered in the state management table 416 is “INTERNAL”, the monitoring unit 430 does not have to perform the determination of the travel status described above. This may reduce processing load when the mobile phone 400 is located internally and reduces power consumption. However, in a case where the travel status for “INTERNAL” is to be managed, the determination of the travel status described above may be performed when the internal/external setting is “INTERNAL”.

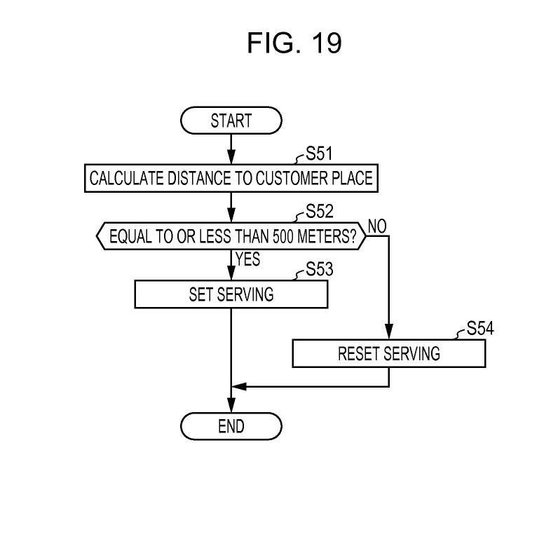

FIG. 19 is diagram illustrating an example of an operational flowchart for determination of customer serving performed by a client, according to an embodiment. The operations depicted in FIG. 19 will be described in order of the step number. In the following description, the mobile phone 400 is taken as an example. However, a similar procedure is applicable to other clients.

(Step S51) The monitoring unit 430 obtains the latitude and longitude of the current position from the GPS communication unit 408. The monitoring unit 430 calculates the distance from the current position to the destination (customer place) with reference to the destination management table 415. For calculation of the distance, for example, the Pythagorean theorem, the Hubeny formula, the Lambert-Andoyer formula, the Haversine formula, or so on may be used.

(Step S52) The monitoring unit 430 determines whether the distance to the destination is equal to or less than 500 meters based on the calculated value. When the distance is equal to or less than 500 meters, the processing proceeds to step S53. When the distance is more than 500 meters, the processing proceeds to step S54.

(Step S53) The monitoring unit 430 sets the customer serving status item of the state management table 416 to “SERVING”. Then, the processing ends.

(Step S54) The monitoring unit 430 deletes “SERVING” set in the customer serving status item of the state management table 416 (reset “SERVING”). Then, the processing ends.

When the internal/external setting registered in the state management table 416 is “EXTERNAL”, the monitoring unit 430 performs the determination of customer serving described above. Although the customer serving status is determined by checking whether the distance to the destination is equal to or less than 500 meters in step S52, this threshold value may be a different value such as 300 or 200 meters, for example. A plurality of destinations may be registered in the destination management table 415. The monitoring unit 430 executes the above procedure for each of the plurality of destinations. In addition, the monitoring units of the clients perform the above procedure periodically.

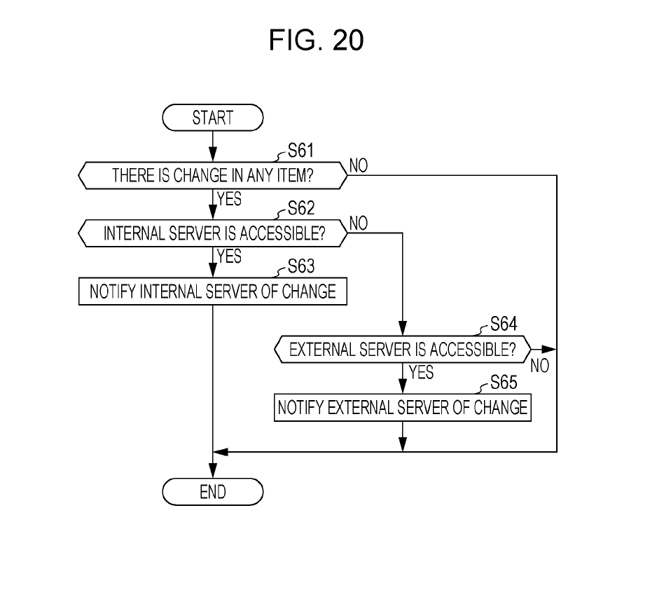

FIG. 20 is a diagram illustrating an example of an operational flowchart for notification of state changes performed by a client, according to an embodiment. The operations depicted in FIG. 20 will be described in order of the step number. In the following description, the PC 300 is taken as an example. However, a similar procedure is applicable to other clients.

(Step S61) The linkage unit 320 determines whether there is a change in any item of the state management table. When there is a change, the processing proceeds to step S62. When there is no change, the processing ends.

(Step S62) The linkage unit 320 determines whether the internal server 100 is accessible. When the internal server 100 is accessible, the processing proceeds to step S63. When the internal server 100 is not accessible, the processing proceeds to step S64.

(Step S63) The linkage unit 320 notifies the internal server 100 of the change in the state management table. The linkage unit 320 adds the machine number of the PC 300 to this notification. The linkage unit 320 may notify the internal server 100 of changes in internal/external information in the state management table. The linkage unit 320 notifying the internal server 100 of changes in internal/external information means the notification of information indicating accessibility to internal or external network.

(Step S64) The linkage unit 320 determines whether the external server 200 is accessible. When the external server 200 is accessible, the processing proceeds to step S65. When the external server 200 is not accessible, the processing ends. Here, a case where the mobile phones 400 or 400a is located internally and unable to access the internal server 100 may occur. In this case, the mobile phones 400 or 400a may access the external server 200 via a mobile communication network. That is, in processing by the linkage unit 420, the internal server 100 is not accessible internally, but the external server 200 may be accessible.

(Step S65) The linkage unit 320 notifies the external server 200 of the change in the state management table. The linkage unit 320 adds the machine number of the PC 300 to this notification. The linkage unit 320 may notify the external server 200 of changes in internal/external information in the state management table. The linkage unit 320 notifying the external server 200 of changes in internal/external information means the notification of information indicating accessibility to internal or external network.

In another example, the state of the PC 300 may be changed by the monitoring unit 330 from “ONLINE” to “LEAVING SEAT”. In this case, the linkage unit 320 detects the change and notifies the internal server 100 that the state of the PC 300 has been changed from “ONLINE” to “LEAVING SEAT”.

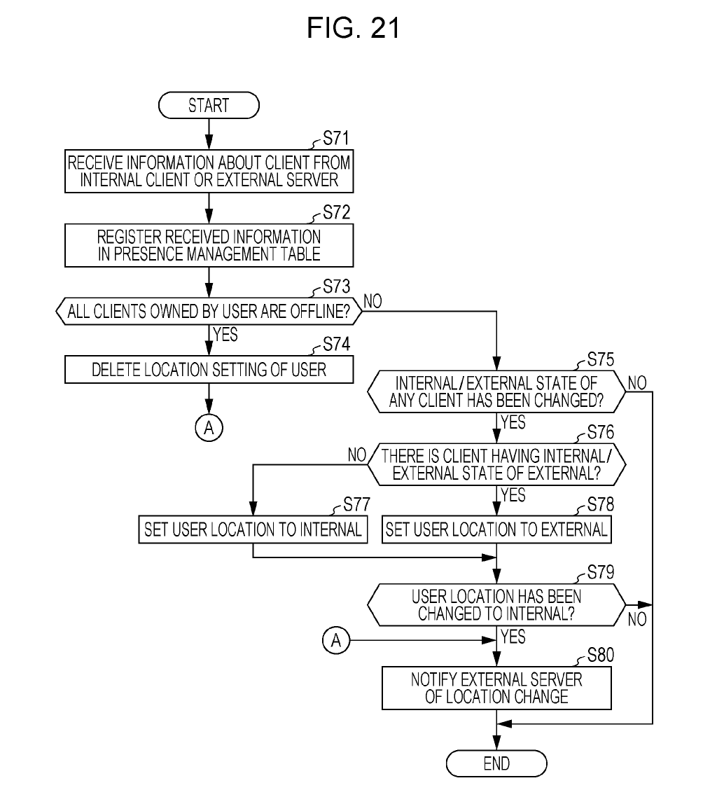

FIG. 21 is a diagram illustrating an example of an operational flowchart for processing performed by an internal server, according to an embodiment. The operations depicted in FIG. 21 will be described in order of the step number.

(Step S71) The presence management unit 120 of the internal server 100 receives information indicating the state of the client from an internal client or the external server 200.

(Step S72) The presence management unit 120 registers the received information in the presence management table 113 stored in the storage unit 110. At this time, the last access time is also updated. The presence management unit 120 references the account management table 111 based on the machine number of a client included in the received information, and determines a user who owns the client. Here, it is also possible to identify the machine number based on the IP address of the client or so on.

(Step S73) The presence management unit 120 determines whether all the clients owned by the user corresponding to the transmission source client in step S71 are offline with reference to the presence management table 113. When all the clients are offline, the processing proceeds to step S74. When all the clients are not offline, the processing proceeds to step S75.

(Step S74) The presence management unit 120 deletes the setting of the location item of the user in the presence management table 113. Then, the processing proceeds to step S80.

(Step S75) The presence management unit 120 determines whether the internal/external state of any client has been changed in step S72. When the state has been changed, the processing proceeds to step S76. When the state has not been changed, the processing ends.

(Step S76) The presence management unit 120 determines whether there is a client that has an internal/external state of “EXTERNAL” among the clients owned by the user corresponding to the transmission source client in step S71 with reference to the presence management table 113. When there is no client that has an internal/external state of “EXTERNAL”, the processing proceeds to step S77. When there is a client that has an internal/external state of “EXTERNAL”, the processing proceeds to step S78.

(Step S77) The presence management unit 120 sets the location item of the user in the presence management table 113 to “INTERNAL”. When the location item of the user is already set to “INTERNAL”, the “INTERNAL” setting is maintained. The last access time is also updated. Then, the processing proceeds to step S79.

(Step S78) The presence management unit 120 sets the location item of the user in the presence management table 113 to “EXTERNAL”. When the location item of the user is already set to “EXTERNAL”, the “EXTERNAL” setting is maintained. The last access time is also updated. Then, the processing proceeds to step S79.

(Step S79) The presence management unit 120 determines whether the user location has been changed from “EXTERNAL” to “INTERNAL”. When the user location has been changed, the processing proceeds to step S80. When the user location has not been changed, the processing ends.

(Step S80) The presence management unit 120 notifies the external server 200 that the setting of the location of the user has been changed. For example, when the setting of the location of the user is deleted in step S74, the presence management unit 120 notifies the external server 200 that the setting of the location of the user has been deleted. For example, when the location of the user is changed from “EXTERNAL” to “INTERNAL” in step S77, the presence management unit 120 notifies the external server 200 of the change. Then, the external server 200 reflects the changes on the presence management table 211 stored in the storage unit 210 and ends the processing. Then, the processing ends.

In step S80, the presence management unit 120 may transmit information (internal/external information) indicating the state of the changed client to the external server 200 together with the machine number of the client. This allows the information indicating the state of the client to be synchronized between the internal server 100 and the external server 200.

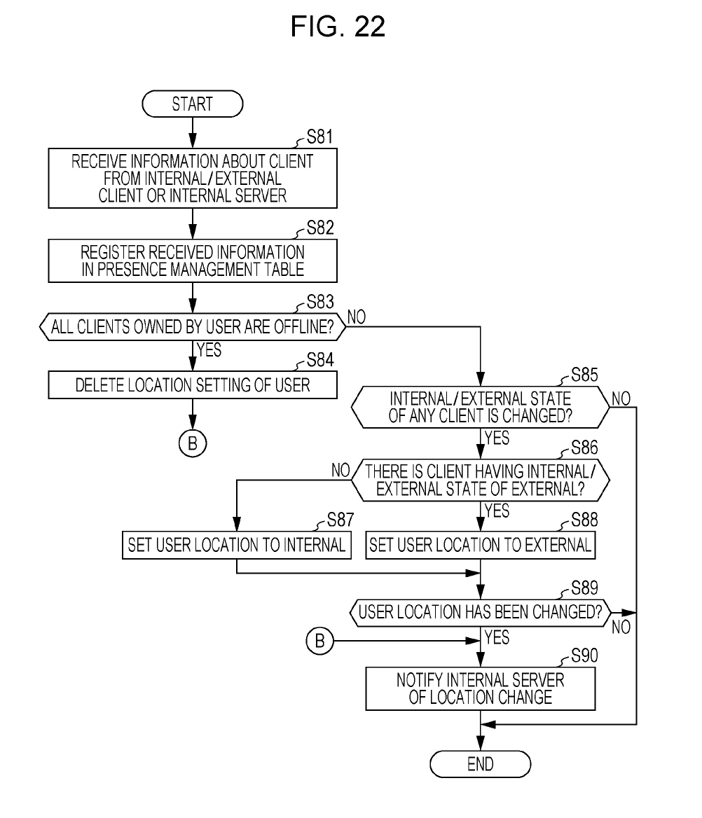

FIG. 22 is a diagram illustrating an example of an operational flowchart for processing performed by an external server, according to an embodiment. The operations depicted in FIG. 22 will be described in order of the step number.

(Step S81) The presence management unit 220 of the external server 200 receives information indicating the states of clients from internal and external clients or the internal server 100.

(Step S82) The presence management unit 220 registers the received information in the presence management table 211 stored in the storage unit 210. At this time, it also updates the last access time. The presence management unit 220 references the account management table 111 on the basis of the machine number of a client included in the received information and determines the user that owns the client. Here, it is also possible to identify the machine number based on the IP address or so on of the client.

(Step S83) The presence management unit 220 determines whether all the clients owned by the user corresponding to the transmission source client in step S81 are offline with reference to the presence management table 211. When all the clients are offline, the processing proceeds to step S84. When all the clients are not offline, the processing proceeds to step S85.

(Step S84) The presence management unit 220 deletes the setting of the location item of the user in the presence management table 211. Then, the processing proceeds to step S90.

(Step S85) The presence management unit 220 determines whether the internal/external state of any client has been changed in step S82. When the state has been changed, the processing proceeds to step S86. When the state has not been changed, the processing ends.

(Step S86) The presence management unit 220 determines whether there is a client that has an internal/external state of “EXTERNAL” among the clients owned by the user corresponding to the transmission source client in step S81 with reference to the presence management table 211. When there is no client that has an internal/external state of “EXTERNAL”, the processing proceeds to step S87. When there is a client that has an internal/external state of “EXTERNAL”, the processing proceeds to step S88.

(Step S87) The presence management unit 220 sets the location item of the user in the presence management table 211 to “INTERNAL”. When the location item of the user is already set to “INTERNAL”, the “INTERNAL” setting is maintained. Then, the processing proceeds to step S89.

(Step S88) The presence management unit 220 sets the location item of the user in the presence management table 211 to “EXTERNAL”. When the location item of the user is already set to “EXTERNAL”, the “EXTERNAL” setting is maintained. Then, the processing proceeds to step S89.

(Step S89) The presence management unit 220 determines whether the user location has been changed from “INTERNAL” to “EXTERNAL” or “EXTERNAL” to “INTERNAL”. When the user location has been changed, the processing proceeds to step S90. When the user location has not been changed, the processing ends.

(Step S90) The presence management unit 220 notifies the internal server 100 that the setting of the location of the user has been changed. For example, when the setting of the location of the user is deleted in step S84, the presence management unit 220 notifies the internal server 100 that the setting of the location of the user has been deleted. For example, when the location of the user is changed from “EXTERNAL” to “INTERNAL” in step S87, the presence management unit 220 notifies the internal server 100 of the change. For example, when the location of the user is changed from “INTERNAL” to “EXTERNAL” in step S88, the presence management unit 220 notifies the internal server 100 of the change. Then, the internal server 100 reflects the changes on the presence management table 113 stored in the storage unit 110 and ends the processing.

In step S90, the presence management unit 220 may transmit information (internal/external information) indicating the state of the changed client to the internal server 100 together with the machine number of the client. This allows the information indicating the state of the client to be synchronized between the internal server 100 and the external server 200.

As described above, when the location of the user is changed, the presence management units 120 and 220 communicate the changes in the location of the user to each other and reflect them on the presence management tables 113 and 211.

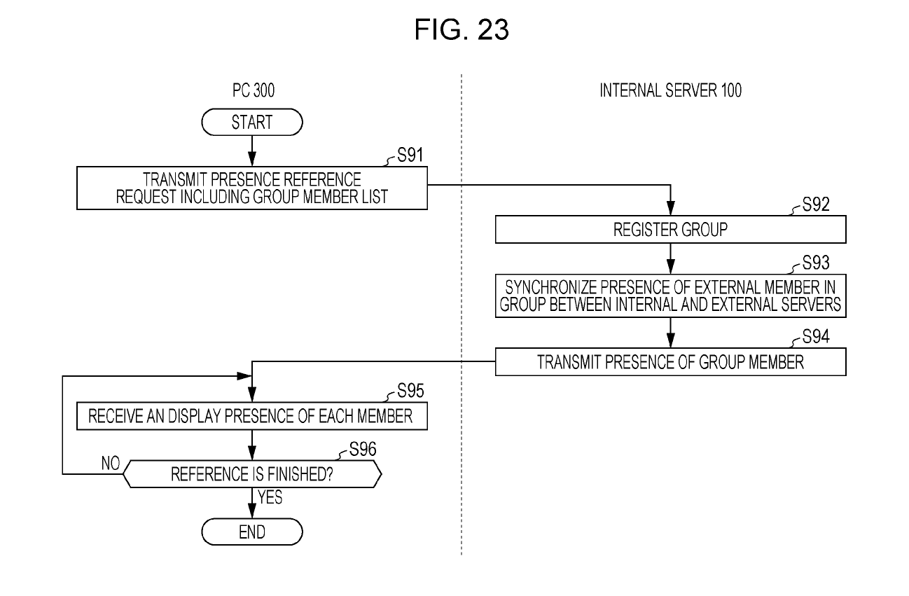

FIG. 23 is a diagram illustrating an example of an operational flowchart for providing presence information for a client, according to an embodiment. The operations depicted in FIG. 23 will be described in order of the step number. In the following example, a user references the presence information of a group member of a group using the PC 300. The PC 300 is assumed to be able to access the internal server 100.

(Step S91) The linkage unit 320 of the PC 300 accepts the user's selection of one of groups registered in the group management table in the storage unit 310. The linkage unit 320 transmits a presence reference request including a list of group members of the selected group (for example, group “MARKETING”) to the internal server 100.

(Step S92) The presence management unit 120 of the internal server 100 receives the presence reference request from the PC 300. The presence management unit 120 registers a list of group members included in the presence reference request in the group management table 112. In addition, the presence management unit 120 obtains the user ID corresponding to the PC 300 and the machine number of the PC 300 from the account management table 111 and registers them in the referencing user item and the requesting user item of the group management table 112. Here, it is also possible to add the machine number of the PC 300 to the presence reference request.

(Step S93) The presence management unit 120 identifies the group members registered in step S92 with reference to the group management table 112. For example, the group members of group “MARKETING” are “A1”, “A2”, “A3”, “A4”, and “A5”. The presence management unit 120 identifies the presence information of the identified group members with reference to the presence management table 113 stored in the storage unit 110. The presence management unit 120 synchronizes the presence information of the group members (external members) for which the location is set to “EXTERNAL” among the identified group members with the presence information in the external server 200 (the group management table is also synchronized). For example, the presence management unit 120 obtains the presence information of the external members “A2”, “A4”, and “A5” of group “MARKETING” from the external server 200 and reflects it on the presence management table 113.

(Step S94) The presence management unit 120 transmits the presence information of the requested group members to the PC 300 with reference to the presence management table 113.

(Step S95) The linkage unit 320 of the PC 300 receives the presence information of group members in response to the presence reference request. The linkage unit 320 registers the presence information of the received group member in the member presence table stored in the storage unit 310. The linkage unit 320 displays the presence information of group members on a display device such as a display with reference to the member presence table.

(Step S96) The linkage unit 320 determines whether to finish the referencing of the presence information. When the referencing of the presence information is not finished, the processing proceeds to step S95 (that is, changes in the presence information of group members are continuously received and they are reflected on the display screen). When the referencing of the presence information is finished, the linkage unit 320 notifies the internal server 100 to finish the referencing and the processing ends. After receiving the notification of finishing the reference, the presence management unit 120 of the internal server 100 deletes the referencing user and the requesting client registered in step S92 from the group management table 112. The presence management unit 120 also deletes the entries that do not include a referencing user and a requesting client from the group management table 112.

As described above, the PC 300 transmits a list of group members of a group for which the PC 300 wants to reference the presence information to the internal server 100 and receives the presence information of the group members from the internal server 100 in response to this. After that, the PC 300 continuously receives the latest present information from the internal server 100 while displaying the presence information, and reflects it on the display screen. The processing between the PC 300 and the internal server 100 is performed as described above. The processing between the PC 300 and the external server 200 may be performed in the similar manner. The individual clients other than the PC 300 are also able to receive the presence information from the internal server 100 and the external server 200 through the PC 300.

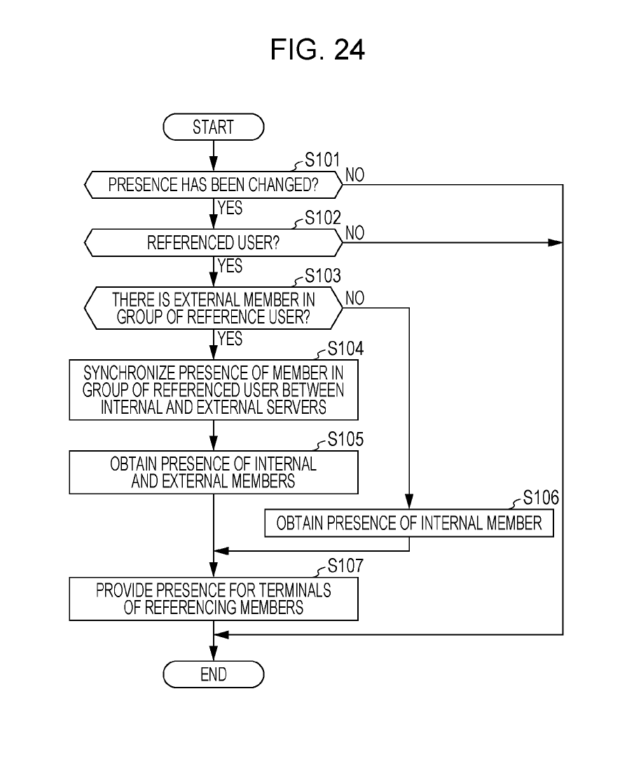

FIG. 24 is a diagram illustrating an example of an operational flowchart for processing performed by an internal server during presence change, according to an embodiment. The operations depicted in FIG. 24 will be described in order of the step number.

(Step S101) The presence management unit 120 determines whether the presence information of any user has been changed with reference to the presence management table 113 stored in the storage unit 110. When the presence information has been changed, the processing proceeds to step S102. When the presence information has not been changed, the processing ends. For example, the presence information of the user may be changed according to a change notification from an internal client or the external server 200 as depicted in steps S71 and S72 in FIG. 21.

(Step S102) The presence management unit 120 determines whether the user corresponding to the presence information to be changed is a user whose presence information is being referenced, with reference to the account management table 111. When the user is the referenced user, the processing proceeds to step S103. When the user is not included in referenced members, the processing ends. In an example of the group management table 112, when the presence information of user “A3” is changed, the presence information of user “A3” is referenced by user “A1”. Accordingly, the user with a user ID of “A3” is a referenced user.

(Step S103) The presence management unit 120 determines whether there is an external member in the group (referenced group) to which a referenced user belongs. When there is an external member, the processing proceeds to step S104. When there is no external member, the processing proceeds to step S106. For example, when the referenced user is the user with a user ID of “A3”, external members “A2”, “A4”, and “A5” are present in group “MARKETING” including the user with a user ID of “A3”.

(Step S104) The presence management unit 120 obtains the presence information of the external members that belong to the referenced group from the external server 200. At this time, the presence management unit 120 provides the presence information of the internal members of the referenced group identified in step S103 for the external server 200. The presence management unit 120 reflects the presence information of the external members obtained from the external server 200 on the presence management table 113 (synchronization of presence). The presence management unit 120 has only to overwrite the settings of the presence management table 113 with the presence information having the latest last access time.

(Step S105) The presence management unit 120 obtains the presence information of the group members of the referenced group with reference to the presence management table 113. Then, the processing proceeds to step S107. This group includes both internal and external members.

(Step S106) The presence management unit 120 obtains the presence information of the group members of the referenced group with reference to the presence management table 113. Step S106 is different from step S105 in that all the group members in step S106 are external members.

(Step S107) The presence management unit 120 provides the presence information of a referenced group for the requesting clients of the users who are referencing the group with reference to the account management table 111 and the group management table 112. When the requesting client is located externally, the requesting clients are provided with the presence information by the external server 200. This updates the presence information referenced by the users to the latest one.

The determination in step S103 keeps synchronization from being made when there is no external member in the referenced group. When no external member is located, there is no internal clients for which the external server 200 has to provide presence information. Accordingly, synchronization is not desired in such a case. Here, it is also possible to omit steps S103 and S106, and to execute step S104 after step S102.

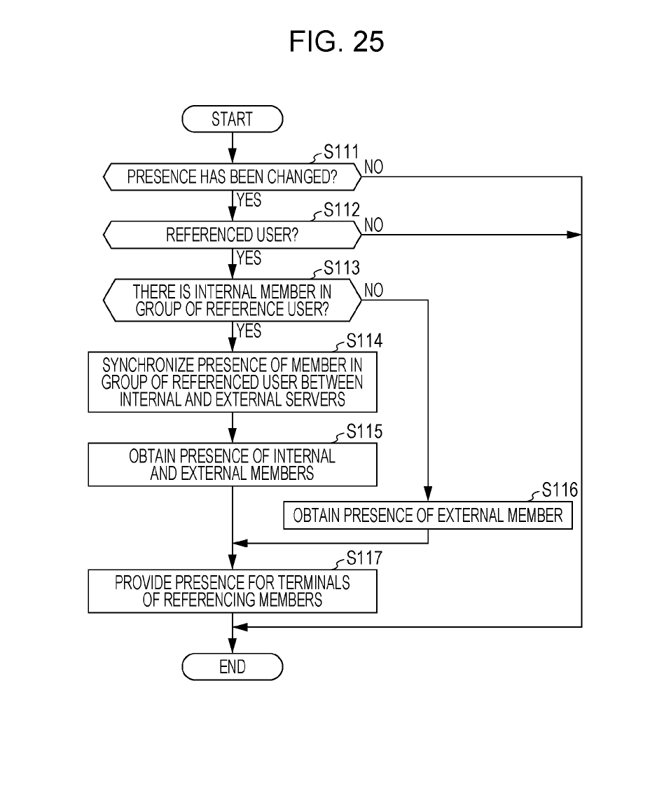

FIG. 25 is a diagram illustrating an example of an operational flowchart for processing performed by an external server during presence change, according to an embodiment. The operations depicted in FIG. 25 will be described in order of the step number.

(Step S111) The presence management unit 220 of the external server 200 determines whether the presence information of any user has been changed with reference to the presence management table 211 stored in the storage unit 210. When the presence information has been changed, the processing proceeds to step S112. When the presence information has not been changed, the processing ends. For example, the presence information of the user may be changed according to a change notification from an internal or external client or the internal server 100 as illustrated in steps S81 and S82 in FIG. 22.

(Step S112) The presence management unit 220 determines whether the user corresponding to the presence information to be changed is the user whose presence information is being referenced, with reference to the account management table stored in the storage unit 210. When the user is the referenced user, the processing proceeds to step S113. When the user is not the referenced user, the processing ends. A specific example of step S112 is not described because it is similar to that of step S102.

(Step S113) The presence management unit 220 determines whether there is an internal member in the group (referenced group) to which a referenced user belongs. When there is an internal member, the processing proceeds to step S114. When there is no internal member, the processing proceeds to step S116. A specific example of step S113 is not described because it is similar to that of step S103.

(Step S114) The presence management unit 220 obtains the presence information of the internal members of the referenced group from the internal server 100. At this time, the presence management unit 220 provides the presence information of the external members of the referenced group identified in step S113 for the internal server 100. The presence management unit 220 reflects the presence information of the internal members obtained from the internal server 100 on the presence management table 211 (synchronization of presence). The presence management unit 220 has only to overwrite the settings of the presence management table 211 with the presence information with the latest last access time.

(Step S115) The presence management unit 220 obtains the presence information of the group members of the referenced group with reference to the presence management table 211. Then, the processing proceeds to step S117. Here, this group includes both the internal and external members.

(Step S116) The presence management unit 220 obtains the presence information of the group members of the referenced group with reference to the presence management table 211. Step S116 is different from step S115 in that all the group members in step S116 are external members.

(Step S117) The presence management unit 220 provides the presence information of the group members of the referenced group for the requesting clients of each user referencing the group, with reference to the account management table and the group management table stored in the storage unit 210. When the requesting client is located internally, the requesting clients are provided with the presence information by the internal server 100. This allows the presence information referenced by the users to be updated to the latest one.

The determination in step S113 keeps synchronization from being made when there is no internal member in the referenced group. When no internal member is present, there is no internal clients for which the internal server 100 has to provide presence information. Accordingly, synchronization is not desired in such a case. Here, it is also possible to execute step S114 after step S112 by omitting the processes in steps S113 and S116.

As described above, even if the presence information is changed, the internal server 100 and the external server 200 are able to reduce the load on communication by synchronizing only the group members of the referenced group as compared with a case where all users of both servers are synchronized to the latest state at any time.

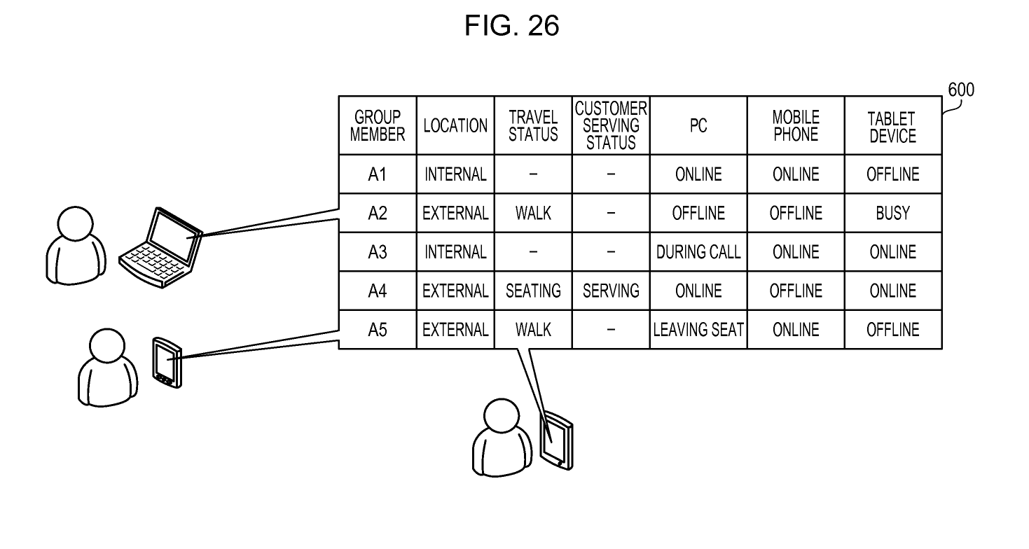

FIG. 26 is a schematic diagram illustrating an example of referencing presence information, according to an embodiment. Each user is able to reference presence information for devices of each group by using its own clients. For example, when the definition of a group is shared with other users, the presence information of the group is shared. For example, when the PC 300, the mobile phone 400, and the tablet device 500 make a presence reference request about the “MARKETING” group, the users are able to share the presence information of this group. For example, each client displays a display screen 600 on its display. The display screen 600 is used to provide the user with the presence information of the group members illustrated in the member presence table 417. Then, the internal server 100 and the external server 200 update the member presence table of each client to the latest state. That is, when the state of any group member is changed, the presence information provided for each client is also updated.

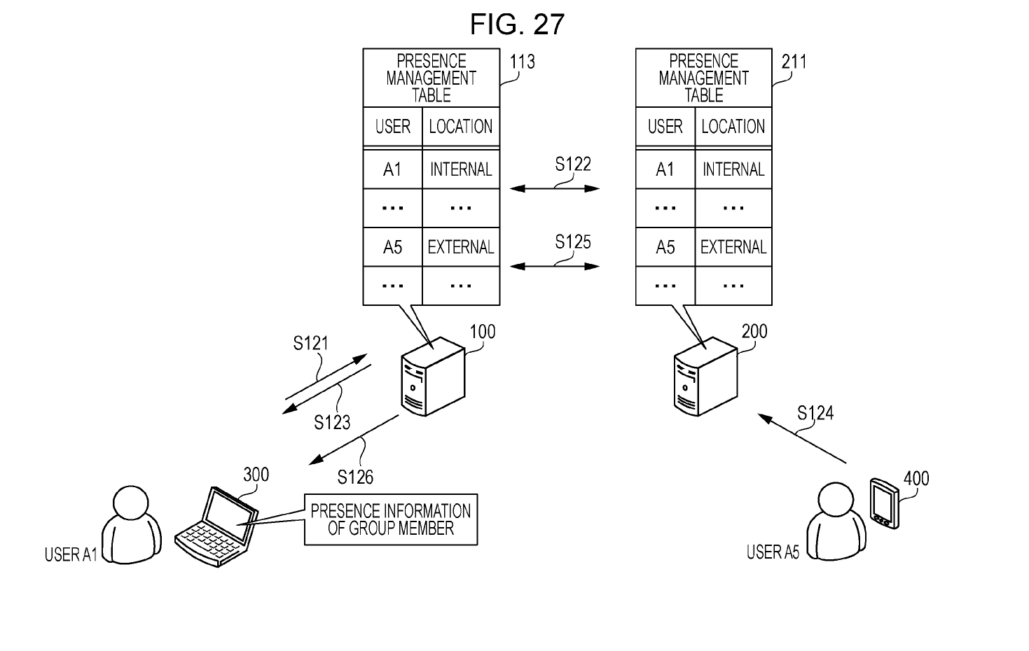

FIG. 27 is a schematic diagram illustrating an example of synchronization of presence information, according to an embodiment. In the illustration in FIG. 27, the user with a user ID of “A1” is represented as user A1. In this example, user A1 uses the PC 300. User A5 uses the mobile phone 400. It is assumed that the PC 300 is located internally and able to access the internal server 100. It is also assumed that the mobile phone 400 is located externally and able to access the external server 200.

The PC 300 transmits a presence information reference request to the internal server 100 (step S121). This request includes a list of the members of the “MARKETING” group. The internal server 100 identifies the presence of an external member (user A5) in the member list. Then, the internal server 100 transmits the member list to the external server 200 to synchronize the presence information of the group members (step S122). The internal server 100 provides the presence information of the group members for the PC 300 (step S123).

Next, the mobile phone 400 notifies the external server 200 that its state has been changed (for example, the travel status has been changed to “TRAIN”) (step S124). The external server 200 identifies user A5 to be a referenced user. The external server 200 identifies the presence of an internal member in the group (“MARKETING” group) including user A5. Then, the external server 200 transmits the member list to the internal server 100 to synchronize the presence information of the group members (step S125). Then, the internal server 100 provides the presence information of the updated group members for the PC 300 of user A1 who is referencing the presence information (step S126).

As described above, the internal server 100 and the external server 200 generate and manage the presence information of one user based on the states of clients owned by each user. In particular, the internal server 100 and the external server 200 identify the location of the user based on the presence information of each client and add the location to the presence information. The internal server 100 and the external server 200 provide the presence information in response to a request from each client, so that each user is able to grasp the locations of other users appropriately.

In addition, the internal server 100 and the external server 200 obtain the travel status of a user by detecting the acceleration pattern of the user using each client. Then, the external server 200 generates the presence information including the travel status of the user by collecting travel information from the client. For example, a user is able to take various travel methods (such as walk, train, or automobile) externally. In this case, when other users are able to grasp the travel method of the user based on the presence information, they are able to grasp detailed information of the location and status of the user.

In addition, information indicating that a user is located at the destination registered in a client or around the destination may be obtained by detecting the position of the user using the client. Then, the external server 200 collects the information from the client and generates, for the user, presence information including the information. For example, the user may sometimes visit a customer to have a meeting. In such a case, when other users are able to know that the user is located at the customer's place or around the customer's place based on the presence information, they are able to grasp the location and state of the user in detail.

As described above, when the travel status and presence of the user around the destination are found, other users are easily able to determine, for example, whether to make contact with the user or how long to put the contact on hold. In addition, other users are easily able to determine what method (such as, for example, telephone, text chat, short messages, or email) to use for making contact.

The internal server 100 and the external server 200 share processing on collection of the client states and provision of presence information to distribute load of collection of information and provision of presence between both the servers. In addition, a request for referencing presence information is accepted in units of groups and presence information is synchronized between the internal server 100 and the external server 200 in units of groups according to this request. This reduces the communication load of synchronization of presence information between the internal server 100 and the external server 200 because the range of users whose presence information is synchronized may be narrowed as compared with a case where the presence information of all the users is synchronized between both the servers at any time.

The functions of the internal server 100 and the external server 200 may be integrated into one server computer. Although a PC, mobile phone, and tablet device are assumed as clients, other devices may be used to manage a users' presence. Users' presence information may be provided using a plurality of types of clients which enable efficient communication.

Here, the internal server 100 may manage the location of a user in more detail. For example, the sites 40 and 50 may be managed separately depending on the AP 11 or 12 accessed by clients. A modification for this purpose will be described below.

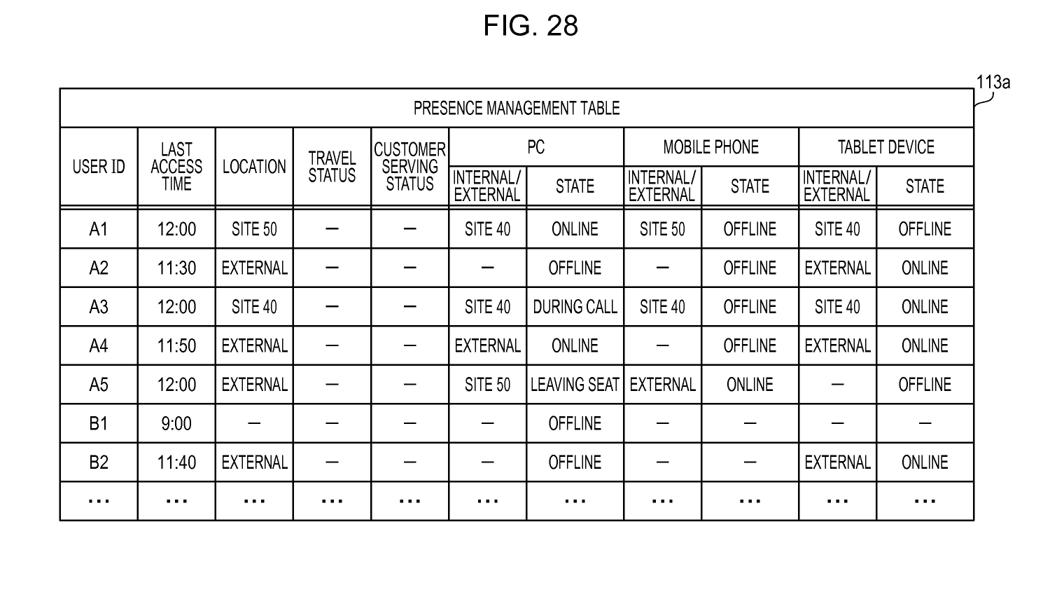

FIG. 28 is a diagram illustrating an example of a presence management table of an internal server, according to an embodiment. The presence management table 113a is stored in the storage unit 110 in place of the presence management table 113. The presence management table 113a includes, as items, a user ID, a last access time, a location, a travel status, a customer serving status, a PC internal/external and state, mobile phone internal/external and state, and tablet device internal/external and state. The information registered in the items of the presence management table 113a is similar to that in the presence management table 113.

For example, the presence management table 113 contains information with a user ID of “A1”, a last access time of “12:00”, a location of “SITE 50”, a travel status of “−”, a customer serving status of “−”, a PC internal/external of “SITE 40”, a PC state of “ONLINE”, a mobile phone internal/external of “SITE 50”, a mobile phone state of “OFFLINE”, a tablet device internal/external of “SITE 40”, and a tablet device state of “OFFLINE”.

That is, the location of user “A1” is the site 50, the PC is located at the site 40 in the “ONLINE” state, the mobile phone is located at the site 50 in the “OFFLINE” state, and the tablet device is located at the site 40 in the “OFFLINE” state. In addition, the presence information of user “A1” was last updated at “12:00”.

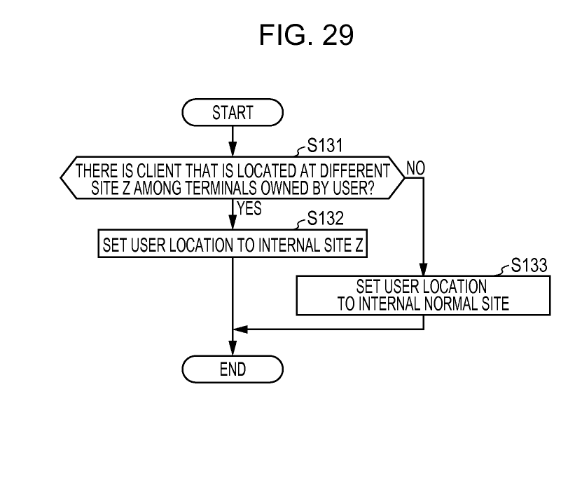

FIG. 29 is a diagram illustrating an example of an operational flowchart for processing performed by an internal server, according to an embodiment. The operations depicted in FIG. 29 will be described in order of the step number. Here, steps S131 to S133 described below are executed in place of step S77 in FIG. 21. In the case, in steps S13 and S14 described in FIG. 15, the clients differentiate between the sites 40 and 50 according to information on the sites 40 and 50 that they access and register their states in the state management table. The presence management unit 120 may register the sites at which the clients are located in the presence management table 113 according to notifications from the clients.

(Step S131) The presence management unit 120 determines whether there is a client located at a site Z different from a normal site among the clients owned by the user, with reference to the presence management table 113. When there is a client, the processing proceeds to step S132. When there is no client, the processing proceeds to step S133. For example, it is considered that the office at which the user normally works is registered in the account management table 111 in advance (for example, the site 40 is registered as the normal site for user A1). This enables the presence management unit 120 to determine whether there is a client located at the site Z different from the normal site with reference to the account management table 111.

(Step S132) The presence management unit 120 sets the location item of the user in the presence management table 113a to internal “SITE Z”. When the location item of the user is already set to “SITE Z”, the current setting is maintained. The last update time is also updated. Then, the processing ends.

(Step S133) The presence management unit 120 sets the location item of the user in the presence management table 113a to the internal normal site. When the location item of the user is already set to the normal site, the setting is maintained. The last update time is also updated. Then, the processing ends.

After the above process, the processing proceeds to step S79, which is described in FIG. 21. In steps S79 and S80, when the internal site of a user is changed (for example, the location is changed from the site 40 to the site 50), the presence management unit 120 notifies the external server 200 of the change.

As described above, the presence management unit 120 is able to determine the internal location of each user for each site by collecting information indicating that which network is accessible from each of the clients owned by one user. This enables the detailed locations of users to be provided appropriately.

As described above, the information processing according to the first embodiment is achieved by causing the calculation unit 1b to execute a program. The information processing according to the second embodiment is achieved by causing the processors included in the internal server 100 and the external server 200 to execute programs. These programs may be recorded in a computer-readable recording medium (such as, for example, the optical disc 15, the memory unit 16, or the memory card 18).

The programs are provided through a portable recording medium that records them. The programs may be stored in the storage device of another computer so that they may be delivered via a network. For example, the computer stores the programs recorded in the portable recording medium or the programs received from the other computer in a storage device and executes the programs by reading them from the storage device. However, the computer may directly execute the programs read from the portable recording medium or may directly execute the programs received from the other computer via a network.

At least a part of the above information processing may be achieved by an electronic circuit such as a DSP, ASIC, PLD, or so on.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method performed by a system including devices associated with users and an information processing device that provides presence information indicating a state of the users, the method comprising:
collecting, by the information processing device, from the devices, pieces of first information indicating which of a plurality of networks is accessible from each of the devices;
identifying, by the information processing device, combination of a plurality of pieces of the first information collected from a plurality of devices associated with a first user by using second information indicating correspondence between the first user and the plurality of devices; and
generating, by the information processing device, first presence information including information indicating a location of the first user, based on the combination.

2. The method of claim 1, further comprising:
determining a location of the first user to be a first area corresponding to a first network when the combination indicates that the first network is accessible from all the plurality of devices associated with the first user; and
determining a location of the first user to be a second area corresponding to a second network when the combination indicates that the second network is accessible from at least one of the plurality of devices associated with the first user.

3. The method of claim 2, further comprising:
obtaining, by a first device that is located in the second area and associated with the first user, travel information indicating a travel method of the first user by detecting an acceleration pattern of the first user;
collecting, by the information processing device, the travel information from the first device; and
generating, for the first user, the first presence information including the travel information.

4. The method of claim 2, further comprising:
obtaining, by a first device that is associated with the first user and located in the second area, destination information indicating that the first user is located at or around a destination registered in the first device;
collecting, by the information processing device, the destination information from the first device; and
generating, for the first user, the first presence information including the destination information.

5. The method of claim 1, wherein
the system includes another information processing device that provides the first presence information indicating a state of users;
the information processing device collects the first information from a first device accessible to a first network;
the another information processing device collects the first information from a second device accessible to a second network; and
the first presence information for the first user is generated by synchronizing the first information collected by the information processing device with the first information collected by the another information processing device.

6. The method of claim 5, wherein,
when the information processing device or the another information processing device receives a request specifying a list of users from a second device, pieces of the first presence information for the users included in the list, held by the information processing device and the other information processing device, are synchronized to generate second presence information, and the generated second presence information of the users included in the list is provided for the second device that has transmitted the request.

7. The method of claim 6, wherein,
after the second presence information is provided in response to the request, when the information processing device or the another information processing device detects a change in the first presence information of one of the users included in the list, the information processing device and the another information processing device synchronize the first presence information of the users included in the list and provide the second presence information of the users included in the list for the second device that transmitted the request.

8. The method of claim 2, wherein
the first area is included in a site and the second area is excluded from the first area.

9. An apparatus for providing presence information indicating a state of a user, the apparatus comprising:
a memory configured to store first information indicating correspondence between a user and a plurality of devices; and
a processor configured:
to collect second information indicating which of a plurality of networks is accessible to each of the plurality of devices, from the plurality of devices,
to identify combination of the second information collected from the plurality of devices associated with the user using the first information, and
to generate the presence information including information indicating a location of the user based on the combination.

10. A non-transitory, computer-readable recording medium stored therein a program for causing a computer to execute a procedure, the computer being included in an information processing device that provides presence information indicating a state of a user for a plurality of devices associated with the user, the procedure comprising:
collecting, by the information processing device, from the devices, a plurality of pieces of access information indicating which of a plurality of networks is accessible from each of the devices;
identifying combination of the plurality of pieces of the first information collected from a plurality of devices associated with a first user by using second information indicating correspondence between the first user and the plurality of devices; and
generating first presence information including information indicating a location of the first user based on the combination.
